(19) United States
(12) Patent Application Publication
(10) Pub. No.: US 2017/0322500 A1
(43) Pub. Date: Nov. 9, 2017

(54) IMAGE FORMING APPARATUS

(71) Applicant: FUJI XEROX CO., LTD., Tokyo (JP)

(72) Inventors: Hirofumi NAKAMURA, Kanagawa (JP); Shigeto HASHIBA, Kanagawa (JP)

(73) Assignee: FUJI XEROX CO., LTD., Tokyo (JP)

(21) Appl. No.: 15/348,371

(22) Filed: Nov. 10, 2016

(30) Foreign Application Priority Data
May 6, 2016 (JP) 2016-093109

(51) Int. Cl. G03G 5/043

(52) U.S. Cl. CPC G03G 5/043

(57) ABSTRACT

An image forming apparatus includes: an electrophotographic photoreceptor which includes an electroconductive substrate, an undercoat layer which is provided on the electroconductive substrate and has an electrostatic capacitance per unit area of from 2×10⁻¹⁰ F/cm² to 2×10⁻F/cm, and a photosensitive layer provided on the undercoat layer; a charging unit that charges a surface of the electrophotographic photoreceptor; an electrostatic latent image forming unit that forms an electrostatic latent image on a charged surface of the electrophotographic photoreceptor; a developing unit that develops the electrostatic latent image formed on the surface of the electrophotographic photoreceptor by using a developer containing a toner, so as to form a toner image; and a direct transfer type transfer unit that directly transfers the toner image onto a surface of a recording medium.

### CROSS-REFERENCE TO RELATED APPLICATIONS

This application is based on and claims priority under 35 USC 119 from Japanese Patent Application No. 2016-093109 filed May 6, 2016.

### BACKGROUND

### 1. Technical Field

The present invention relates to an image forming apparatus.

### 2. Related Art

In the related art, an apparatus for sequentially performing charging, forming an electrostatic latent image, developing, transferring, cleaning, and the like by using an electrophotographic photoreceptor is widely known as an electrophotographic image forming apparatus.

### SUMMARY

According to an aspect of the invention, there is provided an image forming apparatus including:

an electrophotographic photoreceptor which includes an electroconductive substrate, an undercoat layer which is provided on the electroconductive substrate and has an electrostatic capacitance per unit area of from 2×10⁻¹⁰ F/cm² to 2×10⁻⁹ F/cm², and a photosensitive layer provided on the undercoat layer;

a charging unit that charges a surface of the electrophotographic photoreceptor;

an electrostatic latent image forming unit that forms an electrostatic latent image on a charged surface of the electrophotographic photoreceptor;

a developing unit that develops the electrostatic latent image formed on the surface of the electrophotographic photoreceptor by using a developer containing a toner, so as to form a toner image; and

a direct transfer type transfer unit that directly transfers the toner image onto a surface of a recording medium.

### BRIEF DESCRIPTION OF THE DRAWINGS

Exemplary embodiments of the present invention will be described in detail based on the following figures, wherein:

FIG. 1 is a schematic configuration diagram illustrating an example of an image forming apparatus according to an exemplary embodiment;

FIG. 2 is a schematic partially-sectional view illustrating an example of a layer configuration of an electrophotographic photoreceptor according to the exemplary embodiment; and

FIG. 3 is a schematic partially-sectional view illustrating another example of a layer configuration of an electrophotographic photoreceptor according to the exemplary embodiment.

### DETAILED DESCRIPTION

Hereinafter, an exemplary embodiment as an example of the present invention will be described in detail.

Image Forming Apparatus

An image forming apparatus according to the exemplary embodiment includes an electrophotographic photoreceptor, a charging unit, an electrostatic latent image forming unit, a developing unit, and a direct transfer type transfer unit. The charging unit charges a surface of the electrophotographic photoreceptor. The electrostatic latent image forming unit forms an electrostatic latent image on the charged surface of the electrophotographic photoreceptor. The developing unit develops the electrostatic latent image formed on the surface of the electrophotographic photoreceptor by using a developer containing a toner, so as to form a toner image. The direct transfer type transfer unit directly transfers the toner image onto a surface of a recording medium.

The electrophotographic photoreceptor (simply referred to “a photoreceptor” below) includes an electroconductive substrate, an undercoat layer provided on the electroconductive substrate, and a photosensitive layer provided on the undercoat layer. The electrostatic capacitance per unit area of the undercoat layer is from 2×10⁻¹⁰ F/cm² to 2×10⁻⁹ F/cm².

In the image forming apparatus according to the exemplary embodiment, if the electrostatic capacitance per unit area of the undercoat layer is in the above range, fog which may occur when an image is repeatedly formed on short form paper and then an image is formed on long form paper (also simply referred to as “fog” below) is prevented. The reason is unclear, but is supposed as follows.

In a direct transfer type image forming apparatus, a region through which paper passes and a region through which paper does not pass may be provided in accordance with dimensions or a direction of the paper (recording medium), in a transfer region which is a region in which the photoreceptor and the transfer unit face each other. The region through which paper passes may be referred to as “a paper passing region” below. The region through which paper does not pass may be referred to as “a paper unpassing region” below. Because paper has large electric resistance, electric resistance between the photoreceptor and the transfer unit in the paper passing region becomes larger than electric resistance between the photoreceptor and the transfer unit in the paper unpassing region, and thus a difference in electric resistance between the paper passing region and the paper unpassing region occurs.

Here, when a toner image is transferred to a recording medium from the photoreceptor in the direct transfer type image forming apparatus, a transfer voltage is applied to the transfer unit, and thus a transfer current flows from the transfer unit into the photoreceptor. At this time, if a difference in electric resistance between the paper passing region and the paper unpassing region in the transfer region occurs, the current selectively flows in the paper unpassing region of which the electric resistance is small. Thus, relatively many charges are easily accumulated at a portion of the photoreceptor, which corresponds to the paper unpassing region.

As described above, if an image is formed on paper (long form paper) of which the length in the axial direction of the photoreceptor is relatively long, in a state where charges are excessively accumulated at the portion corresponding to the paper unpassing region, a phenomenon (also referred to as “fog” below) in which a toner adheres to a non-image portion, and thus a toner image appears easily occurs. Regarding paper transported to the transfer region, paper of which the length is relatively short in the axial direction of the photoreceptor may be referred below to as “short form paper”, and paper of which the length is relatively long in the axial direction of the photoreceptor may be referred below to as “long form paper”.

Specifically, if an image is repeatedly formed on short form paper, and thus a charging potential is excessively applied, and charges of the opposite polarity are excessively accumulated in the paper unpassing region of the photoreceptor, even when the surface of the photoreceptor is charged in the next charging process, surface charges are canceled by the accumulated charge of the opposite polarity. Thus, poor charging is easily caused. As a result, if an image is repeatedly formed on short form paper, and then an image is formed on long form paper, fog may occur at a portion of the long form paper, which corresponds to the paper unpassing region of the short form paper.

As a case where an image is repeatedly formed on short. form paper, and then an image is formed on long form paper, for example, a case where paper of A4 dimensions is transported in a transverse direction so as to repeat to form an image thereon, and then paper of A4 dimensions is transported in a longitudinal direction so as to form an image thereon is exemplified in addition to a case where paper of A4 dimensions is transported in the transverse direction so as to repeat to form an image thereon, and then paper of A3 dimensions is transported in the transverse direction so as to form an image thereon. However, it is not limited thereto.

Particularly, in a case where an image is formed at a high speed (for example, a recording medium transport speed of 400 mm/s or higher), a toner image is transferred to the recording medium from the photoreceptor for a short time. Thus, applying a higher transfer voltage is required in order to prevent poor transfer which may caused by the insufficient transfer current. If the transfer voltage becomes higher, excessive flowing of the current into the photoreceptor is more easily caused in the paper unpassing region. Thus, poor charging due to the accumulated charges remarkably occurs, and fog is liable to occur more remarkably.

On the contrary, in the exemplary embodiment, the electrostatic capacitance per unit area of the undercoat layer is set to be in the above range, and thus the occurrence of the fog is difficult even though an image is repeatedly formed on short form paper, and then an image is formed on long form paper.

Specifically, the electrostatic capacitance per unit area of the undercoat layer is set to be in the above range which is smaller than that in the related art. Thus, it is difficult to cause the undercoat layer to store charges. Even when the transfer current flows into the photoreceptor from the transfer unit in a transfer process, inflow charges easily flow toward the electroconductive substrate side. Because the inflow charges and charges of the opposite polarity easily move in the undercoat layer, the inflow charges and the charges of the opposite polarity cancel each other, and thus are easily removed. As a result, it is considered that an amount of charges accumulated on the photoreceptor is small at a time point when the next image formation is started. Accordingly, in the next image formation, poor charging which may be caused by many charges accumulated only in a specific region (paper unpassing region of short form paper) is unlikely to occur. Thus, it is supposed that the fog is unlikely to occur.

With the above reason, it is supposed that the electrostatic capacitance per unit area of the undercoat layer is set to be from 2×10⁻¹⁰ F/cm² to 2×10⁻⁹ F/cm² in the direct transfer type image forming apparatus, and thus the image forming apparatus according to the exemplary embodiment prevents the occurrence of fog.

As the recording medium transport speed (process speed), for example, a range of from 400 mm/s to 700 mm/s is exemplified, and the recording medium transport speed is preferably from 450 mm/s to 600 mm/s.

Here, as the image forming apparatus according to the exemplary embodiment, a well-known image forming apparatus as follows is applied: an apparatus which includes a fixing unit configured to fix a toner image transferred onto a surface of a recording medium; an apparatus which includes a cleaning unit configured to perform cleaning of a surface an electrophotographic photoreceptor before charging after transfer of a toner image; an apparatus which includes an erasing unit configured to irradiate a surface of an electrophotographic photoreceptor with erasing light before charging after transfer of a toner image, so as to perform erasing; and an apparatus which includes an electrophotographic photoreceptor heating member configured to increase the temperature of an electrophotographic photoreceptor so as to reduce a relative temperature.

The image forming apparatus according to the exemplary embodiment may be either an image forming apparatus of dry development type or an image forming apparatus of a wet development type (a development type using a liquid developer).

In the image forming apparatus according to the present exemplary embodiment, for example, a portion including the electrophotographic photoreceptor may be a cartridge structure (process cartridge) which is detachable from the image forming apparatus. The process cartridge may further include at least one selected from, for example, a group which is formed from a charging unit, an electrostatic latent image forming unit, a developing unit, and a transfer unit, in addition to the electrophotographic photoreceptor.

In the exemplary embodiment, an image forming apparatus which includes a recharging unit of non-contact charging type on a downstream side of a transfer unit that transfers a toner image, and on an upstream side of a cleaning unit that performs cleaning of a surface of a photoreceptor may be provided. The recharging unit of non-contact charging type charges the surface of the photoreceptor after a toner image has been transferred onto a surface of a recording medium. In the direct transfer type image forming apparatus which includes the recharging unit, the recharging unit performs recharging, and thus it is easy to more prevent the occurrence of fog and to also prevent degradation of image density. In a case where the recharging unit performs recharging, charging of the residual toner which remains on the surface of the photoreceptor after a toner image has been transferred onto a surface of a recording medium is adjusted. Accordingly, the residual toner is easily collected by the cleaning unit, for example.

Hereinafter, the image forming apparatus according to the exemplary embodiment will be described in detail with reference to the drawings.

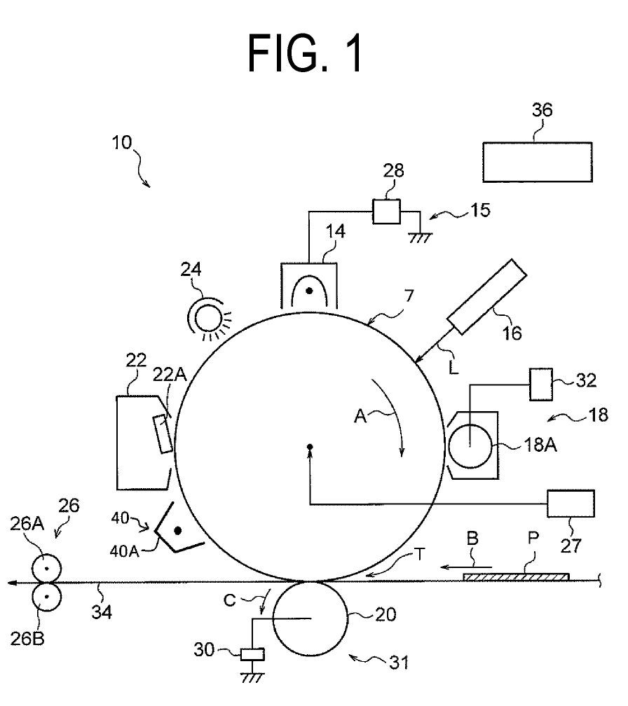

FIG. 1 is a schematic configuration diagram illustrating an example of a configuration of the image forming apparatus according to the exemplary embodiment.

As illustrated in FIG. 1, an electrophotographic photoreceptor 7 is provided in an image forming apparatus 10 according the exemplary embodiment. The electrophotographic photoreceptor 7 has a columnar shape. The electrophotographic photoreceptor 7 is linked to a driving motor 27 (an example of a driving unit) through a driving-force transmission member (not illustrated) such as a gear. The driving motor 27 causes the electrophotographic photoreceptor 7 to be rotationally driven (in a direction indicated by an arrow A in FIG. 1).

For example, the following units are sequentially arranged around the electrophotographic photoreceptor 7 (an example of an image holding member) in a rotation direction of the electrophotographic photoreceptor 7: a charging device (an example of a charging unit) 15; an electrostatic latent image forming device (an example of an electrostatic latent image forming unit) 16; a developing device (an example of a developing unit) 18; a direct transfer type transfer device 31 (an example of a transfer unit; simply also referred to as “a transfer device (“a transfer unit”) below); recharging device 40 of a non-contact charging type (an example of a recharging unit of a non-contact charging type; simply also referred to as “a recharging device” (“recharging unit”) below); a cleaning device (cleaning device) (an example of a cleaning unit) 22; and an erasing device (an example of an erasing unit) 24. A fixing device 26 is also disposed in the image forming apparatus according to the exemplary embodiment. A control device 36 which is connected to the devices and the members in the image forming apparatus 10, and is configured to control operations of the devices and the members is also provided.

A configuration of the image forming apparatus according to the exemplary embodiment will be described below.

Electrophotographic Photoreceptor

As the electrophotographic photoreceptor 7, a photoreceptor having a configuration of including an electroconductive substrate, an undercoat layer provided on the electroconductive substrate, and a photosensitive layer provided on the undercoat layer is applied.

The photosensitive layer may be a photosensitive layer of a function separation type which includes a charge generation layer and a charge transport layer (also referred to as “a function-separated type photosensitive layer” below), or be a photosensitive layer of a single layer type (also referred to as “a single-layer type photosensitive layer” below). In a case where the photosensitive layer is a function-separated type photosensitive layer, the charge generation layer contains a charge generating material, and the charge transport layer contains a charge transporting material.

The electrophotographic photoreceptor according to the exemplary embodiment will be described below in detail with reference to the drawings.

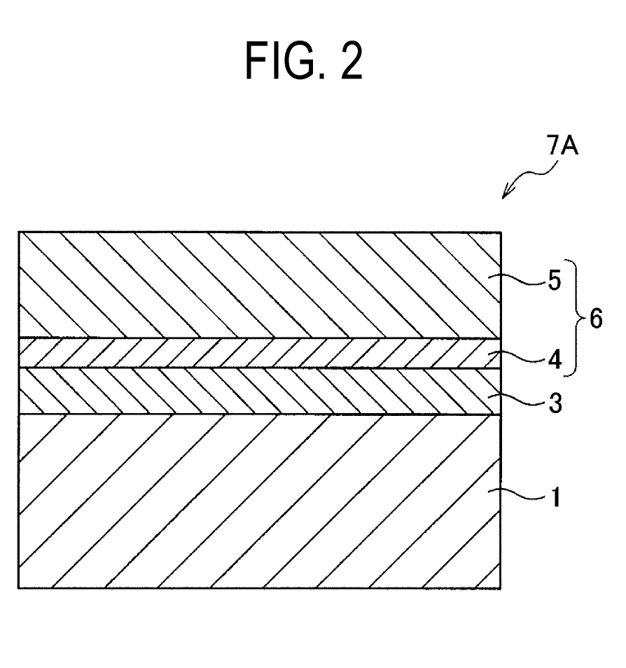

FIG. 2 is a schematic sectional view illustrating an electrophotographic photoreceptor 7A as an example of a layer configuration of the electrophotographic photoreceptor 7. The electrophotographic photoreceptor 7A illustrated in FIG. 2 has a structure in which an undercoat layer 3, a charge generation layer 4, and a charge transport layer 5 are stacked. on an electroconductive substrate 1 in this order. The charge generation layer 4 and the charge transport layer 5 constitute a function-separated type photosensitive layer 6.

The electrophotographic photoreceptor 7A may include other layers if necessary. As the layer provided if necessary, for example, a protective layer which is further provided on the charge transport layer 5 is exemplified.

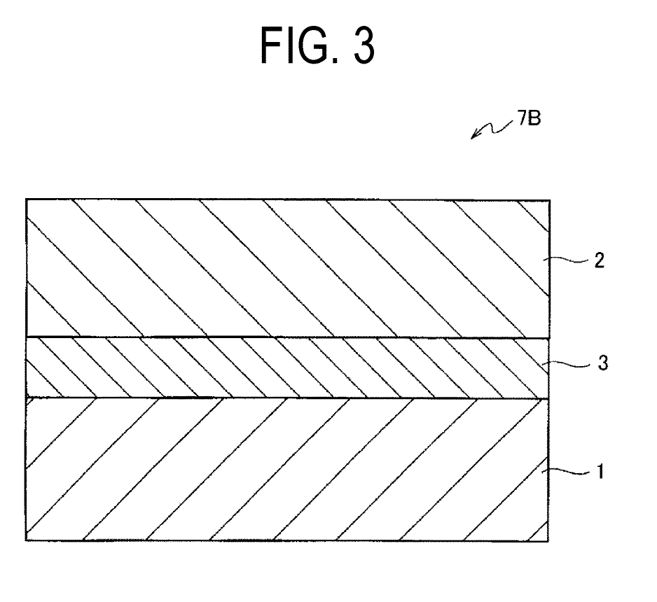

FIG. 3 is a schematic sectional view illustrating an electrophotographic photoreceptor 7B as another example of the layer configuration of the electrophotographic photoreceptor 7. The electrophotographic photoreceptor 7B illustrated in FIG. 3 has a structure in which an undercoat layer 3 and a single-layer type photosensitive layer 2 are stacked on an electroconductive substrate 1 in this order.

The electrophotographic photoreceptor 7B may include other layers if necessary. As the layer provided if necessary, for example, a protective layer which is further provided on the single-layer type photosensitive layer 2 is exemplified.

Each of the layers of the electrophotographic photoreceptor 7 will be described below in detail. Descriptions will be made with the reference signs omitted.

Electroconductive Substrate

Examples of the electroconductive substrate include metal plates, metal drums, and metal belts containing metals (aluminum, copper, zinc, chromium, nickel, molybdenum, vanadium, indium, gold, platinum, and the like) or alloys (stainless steel and the like). Other examples of the electroconductive substrate include paper, resin films, and belts, each formed by applying, depositing, or laminating conductive compounds (for example, a conductive polymer and indium oxide), metals (for example, aluminum, palladium, and gold), or alloys. The term “being conductive” herein refers to having a volume resistivity of less than 10¹³ Ωcm.

In the case where the electrophotographic photoreceptor is used in a laser printer, the surface of the electroconductive substrate is preferably roughened at a center-line average roughness, Ra, which is from 0.04 μm to 0.5 μm in order to prevent an interference fringe generated upon radiation with laser light. In the case where an incoherent light source is used, there no particular need for the surface of the electroconductive substrate to be roughened so as to prevent an interference fringe, and such an incoherent light source may prevent occurrence of defects due to uneven surface of the electroconductive substrate, and is therefore more suitable for prolonging the lifetime.

Examples of a surface roughening method include wet honing in which an abrasive suspended in water is sprayed to a support, centerless grinding in which continuous grinding is carried out by pressing the electroconductive substrate against a rotating grindstone, and an anodization treatment.

Other examples of the surface roughening method include a method in which while not roughening the surface of the electroconductive substrate, conductive or semiconductive powder is dispersed in a resin, the resin is applied onto the surface of the electroconductive substrate to form a layer, and roughening is carried out by the particles dispersed in the layer.

In the surface roughening treatment by anodization, an electroconductive substrate formed of a metal (for example, aluminum) serves as the anode in an electrolyte solution and is anodized to form an oxide film on the surface of the electroconductive substrate. Examples of the electrolyte solution include a sulfuric acid solution and an oxalic acid solution. A porous anodized film formed by anodizing is, however, chemically active in its natural state, and thus, such an anodized film is easily contaminated, and its resistance greatly varies depending on environment. Accordingly, a treatment for closing the pores of the porous anodized film is preferably carried out; in such a process, the pores of the oxidized film are closed by volume expansion due to a hydration reaction in steam under pressure or in boiled water (a metal salt such as nickel may be added), and the porous anodized film is converted into more stable hydrous oxide.

The film thickness of the anodized film is preferably, for example, from 0.3 μm to 15 μm. If the film thickness is within this range, a barrier property for implantation tends to be exerted and an increase in residual potential due to repeated uses tends to be prevented.

The electroconductive substrate may be subjected to a treatment with an acidic treatment solution or a boehmite treatment.

The treatment with an acidic treatment solution is carried out, for example, as follows. An acidic treatment solution containing phosphoric acid, chromic acid, and hydrofluoric acid is prepared. For the blend ratio of the phosphoric acid, the chromic acid, and the hydrofluoric acid in the acidic treatment solution, for example, the amount of the phosphoric acid is in the range from 10% by weight to 11% by weight, the amount of the chromic acid is in the range from 3% by weight to 5% by weight, and the amount of the hydrofluoric acid is in the range from 0.5% by weight to 2% by weight, and the total concentration of these acids is preferably in the range from 13.5% by weight to 18% by weight. The temperature for the treatment is preferably, for example, from 42° C. to 48° C. The film thickness of the coating film is preferably from 0.3 μm to 15 μm.

In the boehmite treatment, for example, the electroconductive substrate is immersed into pure water at a temperature from 90° C. to 100° C. from 5 minutes to 60 minutes or brought into contact with heated water vapor at a temperature from 90° C. to 120° C. from 5 minutes to 60 minutes. The film thickness of the coating film is preferably from 0.1 μm to 5 μm. The obtained product may be subjected to an anodization treatment with an electrolyte solution which less dissolves the coating film, such as adipic acid, boric acid, borate, phosphate, phthalate, maleate, benzoate, tartrate, and citrate.

Undercoat Layer

The undercoat layer is provided between the electroconductive substrate and the photosensitive layer, and has an electrostatic capacitance per unit area of from 2×10⁻¹⁰ F/cm² to 2×10⁻⁹ F/cm².

As described above, the electrostatic capacitance per unit area of the undercoat layer is within the above range, and thus the occurrence of fog is prevented in comparison to a case of being more than the above range. The electrostatic capacitance per unit area of the undercoat layer is within the above range, and thus good electrical characteristics of the photoreceptor are obtained easier than in a case of being less than the above range.

The electrostatic capacitance per unit area of the undercoat layer is preferably from 2×10⁻¹⁰ F/cm² to 2×10⁻⁹ F/cm², and more preferably from 5×10⁻¹⁰ F/cm² to 1×10⁻⁹ F/cm², from a viewpoint of preventing the occurrence of fog.

Here, a method of obtaining the electrostatic capacitance per unit area of the undercoat layer will be described.

For example, as an equivalent circuit of a conductive organic film constituting each of the layers in the electrophotographic photoreceptor, generally, a parallel circuit of a resistor (resistance value: R) and a capacitor (electrostatic capacitance: C) is applied. As a method of analyzing and calculating a resistance value R and an electrostatic capacitance C in a parallel circuit in which the resistance value R and the electrostatic capacitance C are unknown, Cole·Cole Plot analysis is exemplified.

The Cole·Cole Plot analysis refers to a method in which electrodes are attached to both ends of a parallel circuit (for example, conductive organic film) in which a resistance value R and an electrostatic capacitance C are unknown, an AC voltage is applied to the both of the electrodes while changing a frequency, and a positional relationship between the applied voltage and the obtained current is analyzed. The resistance value R and the electrostatic capacitance C in the parallel circuit are obtained by using this method, and the electrostatic capacitance per unit area is obtained based on the obtained value of the electrostatic capacitance C and a value of an area of the attached electrode.

Specifically, for example, firstly, gold electrodes of φ6 mm as facing electrodes are formed on the outer circumferential surface of the undercoat layer by a vapor deposition method, and then measuring is performed at a normal temperature and normal humidity (22° C./50% RH) by the 126096W impedance analyzer (manufactured by Solartron Corp.).

As measuring conditions, for example, a DC vias (applied DC voltage) of 0 V, an AC (applied AC voltage) of ±1 V, and a frequency in a range of from 1 Hz to 100 Hz are exemplified.

The electrostatic capacitance C is obtained based on the obtained measurement result, by the Cole·Cole Plot analysis, and is divided by an electrode area S (cm²) of the facing electrode. Thus, the electrostatic capacitance per unit area of the undercoat layer is calculated.

As a method of measuring the electrostatic capacitance per unit area from a photoreceptor functioning as a measurement, target, for example, the following method is exemplified.

Firstly, a photoreceptor functioning as a measurement target is prepared. Next, for example, a photosensitive layer such as a charge generation layer and a charge transport layer, Which. covers an undercoat layer is removed by using a solvent such as acetone, tetrahydrofuran, methanol, ethanol, and thus the undercoat layer is exposed. A gold electrode is formed on the exposed undercoat layer by a unit, using a vapor deposition method, a sputtering method, or the like, thereby a measurement sample is obtained. Measurement is performed on this measurement sample, and thus the electrostatic capacitance per unit area is obtained.

A method of controlling the electrostatic capacitance per unit area of the undercoat layer is not particularly limited. In a case where the undercoat layer is a layer containing a binder resin, a metal oxide particle, and an electron accepting compound, for example, the following methods are exemplified: a method of adjusting dispersity of metal oxide particles in the undercoat layer; a method of adjusting a particle diameter of the metal oxide particle; a method of adjusting a surface-treating amount of metal oxide particles (that is, an amount of a surface treating agent used in surface treatment of metal oxide particles); a method of adjusting the content of metal oxide particles (content when the surface treating agent is also contained in a case where the surface treating agent adheres to the surfaces of the metal oxide particles); a method of changing a combination of the type of the surface treating agent for the metal oxide particle and the type of the binder resin; a method of adjusting the content of the electron accepting compound; and a method obtained by combining the above-described methods.

Specifically, an appropriate adjusting method varies depending on a condition such as types of various materials, a combination, and the content. For example, if the dispersity of the metal oxide particles is decreased, the electrostatic capacitance of the undercoat layer tends to be decreased. If the dispersity of the metal oxide particles is increased, the electrostatic capacitance of the undercoat layer tends to be increased.

In a case where a coating film of a coating liquid for forming an undercoat layer, in which the metal oxide particles are dispersed, is formed so as to form the undercoat layer, secondary particles obtained by aggregating primary particles may exist along with the primary particles of the metal oxide particles in the film of the formed undercoat layer. The metal oxide particles of the secondary particles have a particle diameter more than that of the primary particles, and existence of these secondary particles cause a path on which charges move to be easily formed. Thus, for example, the dispersity of the metal oxide particles is adjusted to control the metal oxide particles of the secondary particles, so that the electrostatic capacitance per unit area of the undercoat layer is controlled.

Specifically, in a case where the dispersity of the metal oxide particles is low (that is, in a case where a dispersion particle diameter of the metal oxide particles is large), mobility of charges in the undercoat layer is increased, and the electrostatic capacitance per unit area is easily decreased. In a case where the dispersity of the metal oxide particles is high (that is, in a case where the dispersion particle diameter of the metal oxide particles is small), the mobility of charges in the undercoat layer is decreased, and the electrostatic capacitance per unit area tends to be easily increased.

As the method of adjusting the dispersity, for example, a method of performing adjustment in accordance with a dispersing time and the like of the metal oxide particles when the coating liquid for forming an undercoat layer formed is exemplified.

For example, if the particle diameter of the metal oxide particles is set to be large, the electrostatic capacitance of the undercoat layer is decreased. If the particle diameter of the metal oxide particles is set to be small, the electrostatic capacitance of the undercoat layer tends to be increased.

Further, in a case where a zinc oxide particle which has an amino group and is subjected to surface treatment by the silane coupling agent is used as the metal oxide particle, and an acetal resin is used as the binder resin, for example, if the surface-treating amount of metal oxide particles is large, the dispersity of the metal oxide particles is decreased, and thus the electrostatic capacitance of the undercoat layer is decreased. If the surface-treating amount of the metal oxide particles is small, the dispersity of the metal oxide particles is increased, and thus the electrostatic capacitance of the undercoat layer tends to be increased.

For example, if the content of the metal oxide particles is large, an amount of the binder resin is decreased, and thus the electrostatic capacitance of the undercoat layer is decreased. If the content of the metal oxide particles is small, the amount of the binder resin is increased, and thus the electrostatic capacitance of the undercoat layer tends to be increased.

For example, if the content of the electron accepting compound is large, the electrostatic capacitance of the undercoat layer is decreased. If the content of the electron accepting compound is small, the electrostatic capacitance of the undercoat layer tends to be increased.

Regarding a layer which contains the binder resin, the metal oxide particles, and the electron accepting compound, as an example of the undercoat layer, a material, a preparing method, characteristics, and the like will be described below.

Metal Oxide Particle

Examples of the metal oxide particle include a tin oxide particle, a titanium oxide particle, a zinc oxide particle, and a zirconium oxide particle. Among these particles, at least one type selected from the tin oxide particle, the titanium oxide particle, and the zinc oxide particle is preferable, and the zinc oxide particle is more preferable.

As the volume average primary particle diameter of metal oxide particles, for example, a range of 100 nm or less, preferably, a range of from 10 nm to 100 nm is exemplified.

The volume average primary particle diameter of the metal oxide particles is in the above range, and thus uneven distribution in a dispersion, which may be caused by an excessively-large surface area of the metal oxide particles, is prevented in comparison to a case of being less than the above range. The volume average primary particle diameter of the metal oxide particles is in the above range, and thus uneven distribution in the undercoat layer, which may be caused by an excessively-large particle diameter of secondary particles or particles having a high order more than the secondary particles, is prevented in a case of being more than the above range. If the uneven distribution occurs in the undercoat layer, a sea-island structure including a portion at which the metal oxide particles exist and a portion at which the metal oxide particles do not exist is formed in the undercoat layer, and thus an image defect such as unevenness of half-tone density may be caused.

The volume average primary particle diameter of the metal oxide particles is preferably from 20 nm to 70 nm, and more preferably from 30 nm to 50 nm, from a viewpoint of adjusting the electrostatic capacitance per unit area of the undercoat layer to be in the above range.

The volume average primary particle diameter of the metal oxide particles is measured by using a laser-diffraction type particle diameter distribution measuring device (LA-700: HORIBA, Ltd.). Regarding a measuring method, a sample in a state of being a dispersion is adjusted by using a solid powder, so as to be 2 g. Ion exchange water is added to the adjusted sample, thereby 40 ml is obtained. The resultant is inserted into a cell so as to have an appropriate concentration, and waits for 2 minutes. Then, measurement is performed. Among particle diameters of obtained channels, accumulation is performed from a small particle diameter with a volume as a standard. A value when the accumulated value reaches 50% is defined as the volume average primary particle diameter.

As volume resistivity of the metal oxide particles, for example, a range of from 10⁴ Ω·cm to 10¹⁰ Ω·cm is exemplified.

It is preferable that the undercoat layer obtains appropriate impedance at a frequency corresponding to an electrophotographic process speed. From this viewpoint, the volume resistivity of the metal oxide particles is preferably in the above range. That is, the volume resistivity of the metal oxide particles is in the above range, and thus an inclination of particle content dependency of the impedance becomes smaller, and control difficulty of the impedance is easily prevented, in comparison to a case of being lower than the above range. The volume resistivity of the metal oxide particles is in the above range, and thus an increase of the residual potential is prevent easier than in a case of being higher than the above range.

From a viewpoint of adjusting the electrostatic capacitance per unit area of the undercoat layer to be in the above range, the volume resistivity of metal oxide particles is preferably from 3×10⁶ Ω·cm to 3×10⁹ Ω·cm, and more preferably from 5×10⁶ Ω·cm to 1×10⁹ Ω·cm.

The volume resistivity of metal oxide particles is measured in the following manner. A measurement environment is defined as a temperature of 20° C., and humidity of 50% RH.

Firstly, metal oxide particles are separated from the layer. The separated metal oxide particles to be measured are placed on a surface of a circular tool on which an electrode plate of 20 cm² is disposed, so as to have a thickness of about from 1 mm to 3 mm. Thus, a metal oxide particle layer is formed. The similar electrode plate of 20 cm² is placed on the formed metal oxide particle layer, and thus the metal oxide particle layer is nipped between the electrode plates in order to cause void between the metal oxide particles not to be provided, a load of 4 kg is applied onto the electrode plate placed on the metal oxide particle layer, and then the thickness (cm) of the metal oxide particle layer is measured. Both of the electrodes on and under the metal oxide particle layer are connected to an electrometer and a high-voltage power generation device. A high voltage is applied to both of the electrodes, so as to cause an electric field to have a predetermined value. A value (A) of a current flowing at this time is read, and thus the volume resistivity (Ω·cm) of the metal oxide particles is calculated. A calculation expression of the volume resistivity (Ω·cm) of the metal oxide particles is as follows

In the expression, ρ represents the volume resistivity (Ω·cm) of the metal oxide particles, E represents an applied voltage (V) and I represents a current value (A). I₀ represents the current value (A) at the applied voltage of 0 V, and L represents a thickness (cm) of the metal oxide particle layer. In this evaluation, volume resistivity is used when the applied voltage is 1,000 V.

·Expression: ρ=E×20/(I−I₀)/L

As a BET specific surface area of the metal oxide particles, for example, a range of 10 m²/g or more is exemplified. From a viewpoint of adjusting the electrostatic capacitance per unit area of the undercoat layer to be in the above range, the BET specific surface area is preferably from 10 m²/g to 25 m²/g, and more preferably from 15 m²/g to 20 m²/g.

The BET specific surface area has a value measured by a nitrogen substitution method using a BET specific surface area measuring instrument (FLOWSORP II 2300 manufactured by Shimadzu Corporation).

As the content of the metal oxide particles, for example, a range of from 30% by weight to 60% by weight with respect to the total solid content of the undercoat layer is exemplified. From a viewpoint of maintaining electrical characteristics, the content of the metal oxide particles is preferably from 35% by weight to 55% by weight. From a viewpoint of adjusting the electrostatic capacitance per unit, area of the undercoat layer to be in the above range, the content of the metal oxide particles is preferably from 30% by weight to 50% by weight, and more preferably from 35% by weight to 45% by weight, with respect to the total solid content of the undercoat layer.

The metal oxide particles may be subjected to surface treatment by using a surface treating agent, and is preferably subjected to surface treatment by using one or more types of coupling agents among surface treating agents. The coupling agent generally has an action of chemically bonding an organic material and an inorganic material. For example, a compound containing a functional group which has affinity or reactivity with the surfaces of the metal oxide particles is exemplified.

As the metal oxide particle, a mixture of two or more types of metal oxide particles which are subjected to different surface treatments may be used, or a mixture of two or more types of metal oxide particles which have different particle diameters may be used.

Examples of the surface treating agent include a silane coupling agent, a titanate coupling agent, an aluminum coupling agent, and a surfactant. Particularly, a silane coupling agent is preferable, and a silane coupling agent having an amino group is more preferable.

Examples of the silane coupling agent having an amino group include, but are not limited to, 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane.

Two or more types of silane coupling agents may be used as a mixture. For example, the silane coupling agent having an amino group may be used in combination with another silane coupling agent. Examples of such another silane coupling agent include, but are not limited to, vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

The surface treatment method by using a surface treating agent may be any known method, and may be either a dry type method or a wet type method.

The metal oxide particles are subjected to surface treatment by, for example, using the coupling agent, and then, if necessary, may be subjected to thermal treatment for the purpose of, for example, improving environment dependency of the volume resistivity of the metal oxide particles. As a temperature in the thermal treatment, for example, a range of from 150° C. to 300° C. is exemplified. As a treating time in the thermal treatment, for example, a range of from 30 minutes to 5 hours is exemplified.

As the treating amount of the surface treating agent, for example, a range of from 0.5% by weight to 10% by weight with respect to the metal oxide particles is exemplified. For example, in a case where a zinc oxide particle subjected to surface treatment by using a silane coupling agent which contains an amino group is used as the metal oxide particle, and the acetal resin is used as the binder resin, the treating amount of the surface treating agent on metal oxide particles is preferably from 0.1% by weight to 7% by weight, and more preferably from 0.5% by weight to 5% by weight, from a viewpoint of adjusting the electrostatic capacitance per unit area of the undercoat layer to be in the above range.

Electron Accepting Compound

The electron accepting compound may be contained in the undercoat layer after having been dispersed together with the metal oxide particles therein, or may be contained in a state of having adhered to the surfaces of the metal oxide particles. In a case where the electron accepting compound is contained in the state of having adhered to the surfaces of the metal oxide particles, the electron accepting compound is preferably a material which conducts a chemical reaction with the surfaces of the metal oxide particles, or a material which adheres to the surfaces of the metal oxide particles. The electron accepting compound may be selectively provided on the surfaces of the metal oxide particles.

An example of the electron accepting compound includes an electron accepting compound which has a quinone skeleton, an anthraquinone skeleton, a coumarin skeleton, a phthalocyanine skeleton, a triphenylmethane skeleton, an anthocyanin skeleton, a flavone skeleton, a fullerene skeleton, a ruthenium complex skeleton, a xanthene skeleton, a benzoxazine skeleton, and a porphyrin skeleton.

The electron accepting compound may be a compound in which substitution with a substituent such as an acidic group (for example, a hydroxyl group, a carboxyl group, and a sulfonyl group), an aryl group, and an amino group is performed in the skeletons.

Particularly, from a viewpoint of adjusting the electrostatic capacitance per unit area of the undercoat layer to be the above range, as the electron accepting compound, an electron accepting compound having an anthraquinone skeleton is preferable. An electron accepting compound having a hydroxy anthraquinone skeleton (anthraquinone skeleton having a hydroxyl group) is more preferable.

A specific example of the electron accepting compound having a hydroxy anthraquinone skeleton includes a compound represented by the following formula (1).

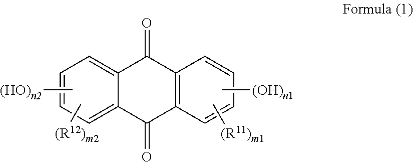

In the formula (1), n1 and n2 each independently represent an integer of from 0 to 3, provided that at least one of n1 and n2 represents an integer of from 1 to 3 (that is, n1 and n2 do not simultaneously represent 0). m1 and m2 each independently represent an integer of 0 or 1. R¹¹ and R¹² each independently represent an alkyl group having from 1 to 10 carbon atoms, or an alkoxy group having from 1 to 10 carbon atoms.

The electron accepting compound may be a compound represented by the following formula (2).

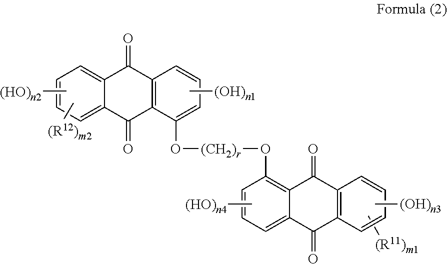

In the formula (2), n1, n2, n3 and n4 each independently represent an integer of from 0 to 3. m1 and m2 each independently represent an integer of 0 or 1. At least one of n1 and n2 each independently represents an integer of from 1 to 3 (that is, n1 and n2 do not simultaneously represent 0). At least one of n3 and n4 each independently represents an integer of from 1 to 3 (that is, n3 and n4 do not simultaneously represent 0). r represents an integer of from 2 to 10. R¹¹ and R¹² each independently represent an alkyl group having from 1 to 10 carbon atoms, or an alkoxy group having from 1 to 10 carbon atoms.

Here, in the formulae (1) and (2), an alkyl group which is represented by R¹¹ and R¹² and has from 1 to 10 carbon atoms may be either of a linear or a branched alkyl group. For example, a methyl group, an ethyl group, a propyl group, and an isopropyl group are exemplified. As the alkyl group having from 1 to 10 carbon atoms, an alkyl group having from 1 to 8 carbon atoms is preferable, and an alkyl group having from 1 to 6 carbon atoms is more preferable.

An alkoxy group (alkoxyl group) which is represented by R¹¹ and R¹² and has from 1 to 10 carbon atoms may be either of a linear or a branched alkoxy group. For example, a methoxy group, an ethoxy group, a propoxy group, and an isopropoxy group are exemplified. As the alkoxy group having from 1 to 10 carbon atoms, an alkoxyl group having from 1 to 8 carbon atoms is preferable, and an alkoxyl group from having 1 to 6 carbon atoms is more preferable.

A specific example of the electron accepting compound will be described below, but is not limited thereto.

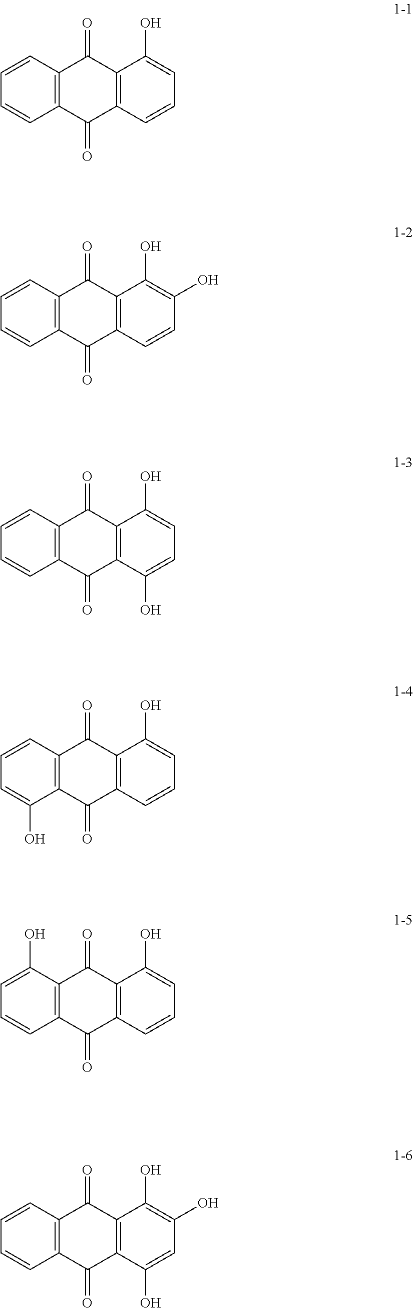 [SMILES: O=C1c2ccccc2C(=O)c2c(O)cccc21 ; O=C1c2ccccc2C(=O)c2c1ccc(O)c2O ; O=C1c2ccccc2C(=O)c2c(O)ccc(O)c21 ; O=C1c2cccc(O)c2C(=O)c2cccc(O)c21 ; O=C1c2cccc(O)c2C(=O)c2c(O)cccc21 ; O=C1c2ccccc2C(=O)c2c(O)c(O)cc(O)c21]

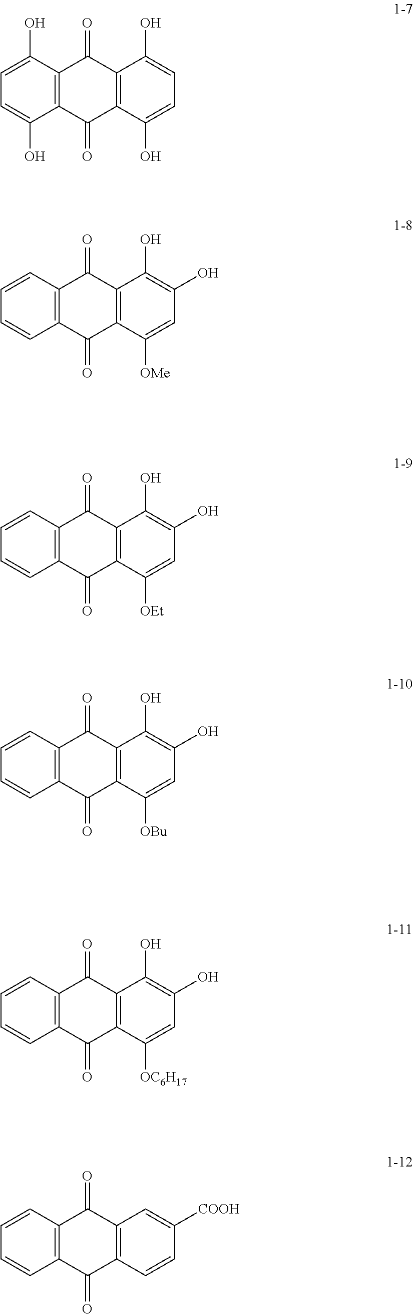

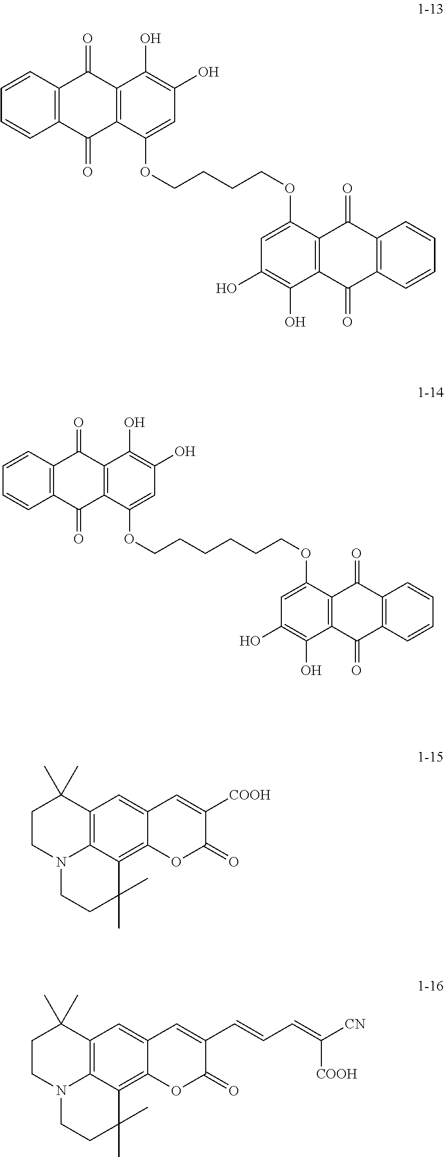 [SMILES: O=C1c2ccccc2C(=O)c2c(O)c(O)cc(OCCCCOc3cc(O)c(O)c4c3C(=O)c3ccccc3C4=O)c21 ; O=C1c2ccccc2C(=O)c2c(O)c(O)cc(OCCCCCCOc3cc(O)c(O)c4c3C(=O)c3ccccc3C4=O)c21 ; CC1(C)CCN2CCC(C)(C)c3c2c1cc1cc(C(=O)O)c(=O)oc31 ; CC1(C)CCN2CCC(C)(C)c3c2c1cc1cc(/C=C/C=C(/C#N)C(=O)O)c(=O)oc31]

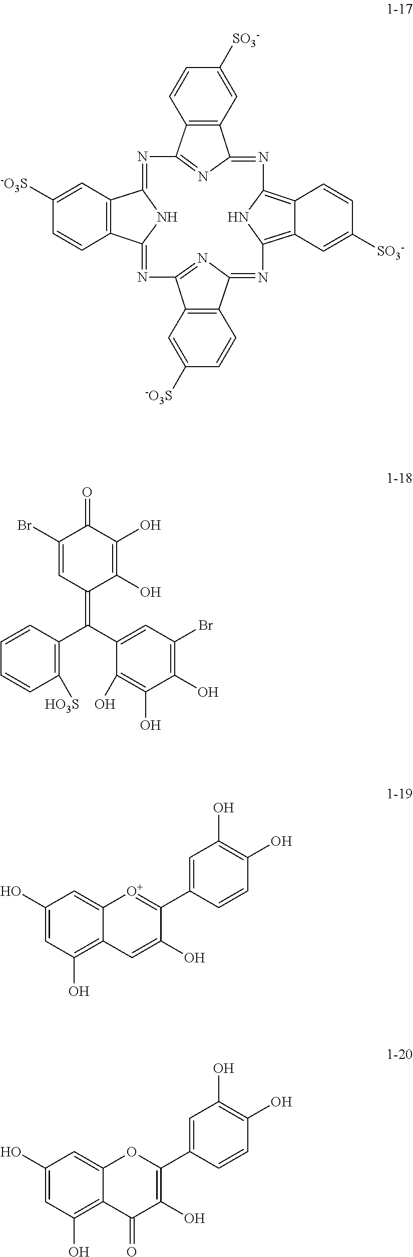

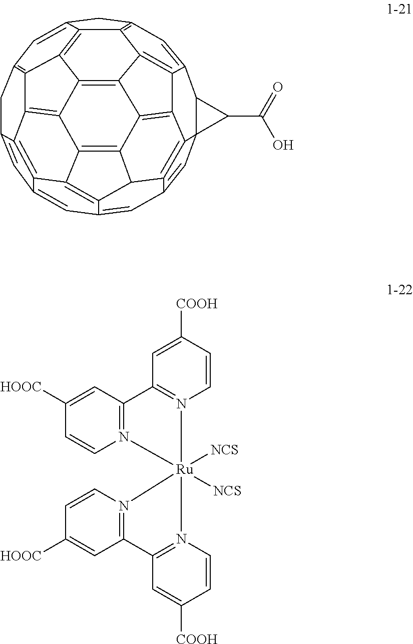

Examples for allowing the electron accepting compound to adhere to the surfaces of the metal oxide particles include a dry type method and a wet type method.

The dry type method is, for example, a method in which an electron accepting compound is allowed to adhere to the surfaces of the metal oxide particles as follows: metal oxide particles are stirred is a mixer with a high shear force, and in this state, the electron accepting compound as at is or as a solution in which the electron accepting compound dissolved in an organic solvent is dropped or sprayed along with dried air or a nitrogen gas. The electron accepting compound may be dropped or sprayed at a temperature that is equal to or lower than the boiling point of the solvent. After dropping or spraying the electron accepting compound, baking may be carried out at equal to or higher than 100° C. Baking may be carried out at any temperature for any length of time provided that electrophotographic properties are obtained.

The wet type method is, for example, a method in which the electron accepting compound is allowed to adhere to the surfaces of the metal oxide particles as follows: the metal oxide particles are dispersed in a solvent by a technique involving stirring, ultrasonic wave, a sand mill, an attritor, or a ball mill, in this state, the electron accepting compound is added thereto and then stirred or dispersed, and the solvent is subsequently removed. The solvent is removed through, for example, being filtered or distilled off by distillation. After the removal of the solvent, baking may be carried out at equal to or higher than 100° C. Baking may be carried out at any temperature for any length of time provided that electrophotographic properties are obtained. In the wet type method, the contained moisture in the metal oxide particles may be removed in advance of the addition of the electron accepting compound, and examples of the wet type method include a method in which the contained moisture is removed by stirring in a solvent under heating or a method in which the contained moisture is removed by azeotropy with a solvent.

The electron accepting compound may be allowed to adhere before or after metal oxide particles are subjected to surface treatment by using the surface treating agent. In addition, the adhesion of the electron accepting compound and the surface treatment with the surface treating agent may be simultaneously carried out.

As the content of the electron accepting compound, for example, a range of from 0.01% by weight to 20% by weight with respect to the total solid content of the undercoat layer is exemplified. The content of the electron accepting compound. is preferably from 0.1% by weight to 10% by weight, and more preferably from 0.5% by weight to 5% by weight.

The content of the electron accepting compound is in the above range, and thus an effect of the electron accepting compound as an acceptor is obtained easier than in a case of being less than the above range. The content of the electron accepting compound is in the above range, and thus it is difficult to aggregate metal oxide particles and to cause uneven distribution of the metal oxide particles to excessively occur in the undercoat layer in comparison to a case of being more than the above range. In addition, it is difficult to cause an increase of the residual potential, occurrence of a black spot, and occurrence of unevenness of half-tone density due to excessive uneven distribution of the metal oxide particles.

From a viewpoint of adjusting the electrostatic capacitance per unit area of the undercoat layer to be in the above range, the content of the electron accepting compound is preferably from 0.1% by weight to 5% by weight, and more preferably from 0.5% by weight to 1% by weight, with respect to the total solid content of the undercoat layer.

Binder Resin

Examples of the binder resin to be used in the undercoat layer include known high molecular compounds such as acetal resins (for example, polyvinyl butyral), polyvinyl alcohol resins, polyvinyl acetal resins, casein resins, polyamide resins, cellulose resins, gelatin, polyurethane resins, polyester resins, unsaturated polyester resins, methacrylic resins, acrylic resins, polyvinyl chloride resins, polyvinyl acetate resins, vinyl chloride-vinyl acetate-maleic anhydride resins, silicone resins, silicone-alkyd resins, urea resins, phenolic resins, phenol-formaldehyde resins, melamine resins, urethane resins, alkyd resins, and epoxy resins; zirconium chelate compounds; titanium chelate compounds; aluminum chelate compounds; titanium alkoxide compounds; organic titanium compounds; and known materials such as silane coupling agents.

Other examples of the binder resin for use in the undercoat layer include charge transporting resins having charge transporting groups and conductive resins (for example, polyaniline).

Among these materials, a resin that is insoluble in a solvent used in coating for forming the upper layer is suitable as the binder resin to be used in the undercoat layer. In particular, resins obtained by a reaction of a curing agent with at least one resin selected from. a group consisting of thermosetting resins such as urea resins, phenolic resins, phenol-formaldehyde resins, melamine resins, urethane resins, unsaturated polyester resins, alkyd resins, and epoxy resins; polyamide resins; polyester resins; polyether resins; methacrylic resins; acrylic resins; polyvinyl alcohol resins; and polyvinyl acetal resins are suitable.

In the case where two or more kinds of these binder resins are used in combination, the mixing ratio thereof is determined, as necessary.

Additive

The undercoat layer may contain various additives in order to improve electrical properties, environmental stability, and image quality.

Examples of the additives include an electron transporting pigment such as a condensed polycyclic pigment and an azo pigment, and known materials such as zirconium chelate compounds, titanium chelate compounds, aluminum chelate compounds, titanium alkoxide compounds, organic titanium compounds, and silane coupling agents. The silane coupling agent is used for the surface treatment of the metal oxide particles as described above, but may be further added to the undercoat layer, as an additive.

Examples of the silane coupling agent as an additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethylmethoxysilane, N,N-bis(2-hydroxyethyl)-3-aminopropyltriethoxysilane, and 3-chloropropyltrimethoxysilane.

Examples of the zirconium chelate compound include zirconium butoxide, zirconium ethyl acetoacetate, zirconium triethanolamine, acetylacetonate zirconium butoxide, ethyl acetoacetate zirconium butoxide, zirconium acetate, zirconium oxalate, zirconium lactate, zirconium phosphonate, zirconium octanate, zirconium naphthenate, zirconium laurate, zirconium stearate, zirconium isostearate, methacrylate zirconium butoxide, stearate zirconium butoxide, and isostearate zirconium butoxide.

Examples of the titanium chelate compound include tetraisopropyl titanate, tetra-normal-butyl titanate, butyl titanate dimers, tetra (2-ethylhexyl) titanate, titanium acetylacetonate, polytitanium acetylacetonate, titanium octylene glycolate titanium lactate ammonium salts, titanium lactate, titanium lactate ethyl esters, titanium triethanol aminate, and polyhydroxytitanium stearate.

Examples of the aluminum chelate compound include aluminum isopropylate, monobutoxyaluminum diisopropylate, aluminum butylate, diethyl acetoacetate aluminum diisopropylate, and aluminum tris(ethyl acetoacetate).

These additives may be used singly or as a mixture or a polycondensate of plural kinds thereof.

The undercoat layer may have Vickers hardness of 35 or more.

In order to prevent a moire fringe, surface roughness (ten-point average roughness) of the undercoat layer may be adjusted to a range from 1/(4n) (n is the refractive index of the upper layer) to ½ of the wavelength λ of the exposure laser to be used.

In order to adjust the surface roughness, resin particles or the like may be added to the undercoat layer. Examples of the resin particles include silicone resin particles and cross-linked polymethyl methacrylate resin particles. In addition, the surface of the undercoat layer may be polished to adjust the surface roughness. Examples of a polishing method include huffing polishing, sand blasting treatment, wet honing, and grinding treatment.

Forming Method of Undercoat Layer

A technique for forming the undercoat layer is not particularly limited, and any known technique is used. For example, a coating film of a coating liquid for forming an undercoat layer, which is obtained adding the above components to a solvent is formed. Then, the formed coating film is dried, and, as necessary, is heated.

Examples of the solvent, used in the preparation of the coating liquid for forming an undercoat layer include known organic solvents such as an alcohol solvent, an aromatic hydrocarbon solvent, a halogenated hydrocarbon solvent, a ketone solvent, a ketone alcohol solvent, an ether solvent, and an ester solvent.

Specific examples of these solvents include common organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of a method for dispersing the metal oxide particles when the coating liquid for forming an undercoat layer is prepared include known methods using a roller mill, a ball mill, a vibratory ball mill, an attritor, a sand mill, a colloid mill, a paint shaker, or the like.

Examples of a method for applying the coating liquid for forming an undercoat layer onto the electroconductive substrate include common methods such as a blade coating method, a wire-bar coating method, a spray coating method, a dip coating method, a bead coating method, an air knife coating method, and a curtain coating method.

The film thickness of the undercoat layer is, for example, set to be in a range of preferably equal to or more than 15 μm, more preferably from 15 μm to 50 μm, further preferably from 15 μm to 30 μm, and particularly preferably from 20 μm to 25 μm.

Intermediate Layer

Although not illustrated, an intermediate layer may further be provided between the undercoat layer and the photosensitive layer.

The intermediate layer is a layer which contains a resin, for example. Examples of the resin used in the intermediate layer include polymeric compounds such as acetal resins (for example, polyvinyl butyral), polyvinyl alcohol resins, polyvinyl acetal resins, casein resins, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenol-formaldehyde resins, and melamine resins.

The intermediate layer maybe a layer which contains an organic metal compound. Examples of the organic metal compound used in the intermediate layer include those that contain metal atoms such as zirconium, titanium, aluminum, manganese, and silicon.

These compounds used in the intermediate layer may be used singly or as a mixture or a polycondensate of plural kinds of the compounds.

Among these materials, the intermediate layer is preferably a layer which contains an organic metal compound containing a zirconium atom or a silicon atom.

A technique for forming the intermediate layer is not particularly limited, and known methods are used. For example, a coating film for a coating liquid for forming an intermediate layer, which is obtained by adding the above components to a solvent is formed. Then, the formed coating film is dried, and, if necessary, is heated.

As a coating method used for forming the intermediate layer, common methods such as a dip coating method, an extrusion coating method, a wire bar coating method, a spray coating method, a blade coating method, a knife coating method, and a curtain coating method are used.

The film thickness of the intermediate layer is preferably set to in a range of from 0.1 μm to 3 μm, for example. The intermediate layer may be used as the undercoat layer.

Charge Generation layer

The charge generation layer is a layer including, for example, a charge generating material and a binder resin. Further, the charge generation layer may be a vapor-deposited layer of a charge generating material. The vapor-deposited layer of a charge generating material is suitable in the case where an incoherent light source such as a Light Emitting Diode (LED) or an Organic Electro-Luminescence (EL) image array is used.

Examples of the charge generating material include azo pigments such as bisazo and trisazo pigments, fused aromatic pigments such as dibromoanthanthrone; perylene pigments; pyrrolopyrrole pigments; phthalocyanine pigments; zinc oxide; and trigonal selenium.

Among these, a metal phthalocyanine pigment or a metal-free phthalocyanine pigment is preferably used as a charge generating material in order to be compatible with laser exposure a near-infrared region. Specifically, for example, hydroxygallium phthalocyanine; chlorogallium phthalocyanine; dichlorotin phthalocyanine; and titanyl phthalocyanine are more preferable.

In order to be compatible with laser exposure in a near-ultraviolet region, fused aromatic pigments such as dibromoanthanthrone; thioindigo pigments; porphyrazine compounds; zinc oxide; trigonal selenium, bisazo pigments are preferable as the charge generating material.

The charge generating materials may be used even in the case where an incoherent light source such as an organic EL image array or an LED having a center wavelength for light emission within the range from 450 nm to 780 nm is used. However, when the photosensitive layer is designed as a thin film having a thickness of equal to or less than 20 μm from the viewpoint of resolution, the electric field strength in the photosensitive layer increases and electrification obtained from charge injection from the electroconductive substrate decreases, thereby readily generating image defects referred to a so-called black spot. This phenomenon becomes notable when a charge generating material, such as trigonal selenium or a phthalocyanine pigment, that readily generates dark current in a p-type semiconductor is used.

In contrast, when an n-type semiconductor such as a fused aromatic pigment, a perylene pigment, and an azo pigment is used as the charge generating material, dark current rarely occurs and image defects referred to black spot are prevented even in the case where the photoconductive layer is in the form of a thin film.

Furthermore, whether the material is of an n-type is determined by the polarity of the photocurrent that flows in a commonly used time-of-flight method and the material in which electrons rather than holes easily flow as a carrier is identified as the n-type.

The binder resin used in the charge generation layer may be selected from a wide variety of insulating resins. Further, the binder resin may be selected from organic photoconductive polymers such as poly-N-vinylcarbazole, polyvinylanthracene, polyvinylpyrene, and polysilane.

Examples of the binder resin in the charge generation layer include polynyl butyral resins, polyarylate resins (a polycondensate of a bisphenol and a divalent aromatic dicarboxylic acid, and the like), polycarbonate resins, polyester resins, phenoxy resins, vinyl chloride-vinyl acetate copolymers, polyimide resins, acrylic resins, polyacrylamide resins, polyvinyl pyridine resins, cellulose resins, urethane resins, epoxy resins, casein, polyvinyl alcohol resins, and polyvinyl pyrrolidone resins. The term “being insulating” herein refers to having a volume resistivity of equal to or more than 10¹³ Ωcm.

The binder resin may be used alone or as a mixture of two or more kinds thereof.

Moreover, the blend ratio of the charge generating material to the binder resin is preferably in the range from 10:1 to 1:10 in terms of weight ratio.

The charge generation layer may include other known additives.

A technique for forming the charge generation layer is not particularly limited, and known forming methods are used. For example, formation of the charge generation layer is carried out by forming a coating film of a coating liquid for forming a charge generation layer in which the components are added to a solvent, and drying the coating film, followed by heating, as desired. Further, formation of the charge generation layer may be carried out by vapor deposition of the charge generating materials. Formation of the charge generation layer by vapor deposition is particularly suitable in the case where a fused aromatic pigment or a perylene pigment is used as the charge generating material.

Examples of the solvent for preparing the coating liquid for forming a charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents may be used alone or as a mixture of two or more kinds thereof.

For a method for dispersing particles (for example, charge generating materials) in the coating liquid for forming a charge generation layer, media dispersers such as a ball mill, a vibratory ball mill, an attritor, a sand mill, and a horizontal sand mill or a medialess disperser such as a stirrer, an ultrasonic disperser, a roller mill, and a high-pressure homogenizer are used. Examples of the high-pressure homogenizer include a collision-type homogenizer in which dispersing is performed by subjecting the dispersion to liquid-liquid collision or liquid-wall collision in a high-pressure state and a penetration-type homogenizer in which dispersing is performed by causing the dispersion to penetrate fine channels in a high pressure state.

Incidentally, during the dispersion, it is effective to adjust the average particle diameter of the charge generating material in the coating liquid for forming a charge generation layer to equal to or less than 0.5 μm, preferably equal to or less than 0.3 μm, and more preferably equal to or less than 0.15 mm.

Examples of the method for applying the undercoat layer (or the intermediate layer) with the coating liquid for forming a charge generation layer include common methods such as a blade coating method, a wire bar coating method, a spray coating method, a dip coating method, a bead coating method, an air knife coating method, and a curtain coating method.

The film thickness of the charge generation layer is set to be, for example, preferably in the range from 0.1 μm to 5.0 μm, and more preferably in the range from 0.2 μm to 2.0 μm.

Charge Transport Layer

The charge transport layer is, for example, a layer which contains a charge transporting material and a binder resin. The charge transport layer may be a layer which contains a charge transporting polymer material.

Examples of the charge transporting material include electron transporting compounds which include, for example, a quinone compound such as p-benzoquinone, chloranil, bromanil, and anthraquinone; a tetracyanoquinodimethane compound; a fluorenone compound such as 2,4,7-trinitrofluorenone; a xanthone compound; a benzophenone compound; a cyanovinyl compound; and an ethylene compound. Examples of the charge transporting material also include hole transporting material such as a triarylamine compound, a benzidine compound, an arylalkane compound, an aryl substituted ethylene compound, a stilbene compound, an anthracene compound, and a hydrazone compound. The charge transporting material is used singly or in combination of two or more types, and it is not limited thereto.

From a viewpoint of charge mobility, triarylamine derivatives represented by the following formula (a-1) and benzidine derivatives represented by the following formula (a-2) are preferable as the charge transporting material.

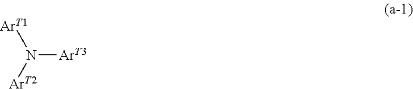

In the formula (a-1), Ar^{T1}, Ar^{T2}, and Ar^{T3} each independently represent a substituted or unsubstituted aryl group, —C₆H₄—C (R^{T4})═C(R^{T5}) (R^{T6}), or —C₆H₄—CH═CH—CH═C (R^{T7}) (R^{T8}). R^{T4}, R^{T5}, R^{T6}, R^{T7}, and R^{T8} each independently represent a hydrogen atom, a substituted or unsubstituted alkyl group, or a substituted or unsubstituted aryl group.

As a substituent of each of the groups, a halogen atom, an alkyl group having from, 1 to 5 carbon atoms, and an alkoxy group having from 1 to 5 carbon atoms are exemplified. As a substituent of each of the groups, a substituted amino group which has been substituted with an alkyl group having from 1 to 3 carbon atoms is also exemplified.

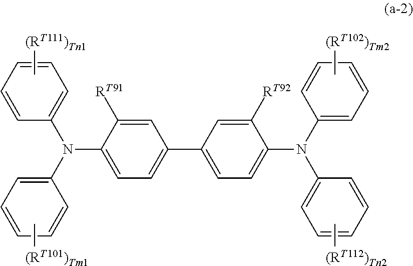

In the formula (a-2), R^{T91} and R^{T92} each independently represent a hydrogen atom, a halogen atom, an alkyl group having from 1 to 5 carbon atoms, or an alkoxy group having 1 to 5 carbon atoms. R^{T101}, R^{T102}, R^{T111}, and R^{T112} each independently represent a halogen atom, an alkyl group having from 1 to 5 carbon atoms, an alkoxy group having from 1 to 5 carbon atoms, an amino group substituted with an alkyl group having from 1 to 2 carbon atoms, substituted or unsubstituted aryl group, —C(R^{T12})═C(R^{T13}) (R^{T14}), or —CH═CH—CH═C(R^{T15}) (R^{T16}). R^{T12}, R^{T13}, R^{T14}, R^{T15}, and R^{T16} each independently represent a hydrogen atom, a substituted or unsubstituted alkyl group, a substituted or unsubstituted aryl group. Tm1, Tm2, Tn1, and Tn2 each independently represent an integer of from 0 to 2.

As a substituent of each of the groups, a halogen atom, an alkyl group having from 1 to 5 carbon atoms, and an alkoxy group having from 1 to 5 carbon atoms are exemplified. As a substituent of each of the groups, a substituted amino group which has been substituted with an alkyl group having from 1 to 3 carbon atoms is also exemplified.

Here, among triarylamine derivatives represented by the formula (a-1) and benzidine derivatives represented by the formula (a-2), particularly, triarylamine derivative having “—C₆H₄—CH═CH—CH═C (R^{T7}) (R^{T8})”, and benzidine derivative having “—CH═CH—CH═C (R^{T15}) (R^{T16})” are preferable from a viewpoint of the charge mobility.

From a viewpoint of charge mobility, examples of the charge transporting material preferably include a butadiene charge transporting material (CT1) represented by the following formula (CT1).

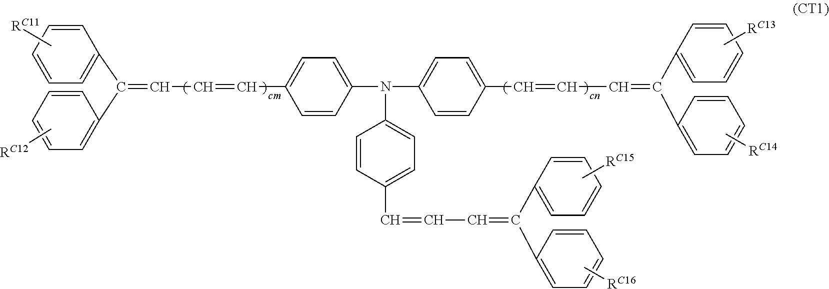

In the formula (CT1), R^{C11}, R^{C12}, R^{C13}, R^{C14}, R^{C15}, and R^{C16} each independently represent a hydrogen atom, a halogen atom, an alkyl group having from 1 to 20 carbon atoms, an alkoxy group having from 1 to 20 carbon atoms, or an aryl group having from 6 to 30 carbon atoms, and two adjacent substituents may be bonded to each other to form a hydrocarbon ring structure.

cm and cn each independently represent 0, 1, or 2.

In the formula (CT1), examples of the halogen atoms represented by R^{C11}, R^{C12}, R^{C13}, R^{C14}, R^{C15}, and R^{C16} include a fluorine atom, a chlorine atom, a bromine atom, and an iodine atom. Among these, as the halogen atom, a fluorine atom and a chlorine atom are preferable, and a chlorine atom is more preferable.

In the formula (CT1), examples of the alkyl groups represented by RC¹¹, RC¹², RC¹³, RC¹⁴, RC¹⁵, and RC¹⁶ include a linear or branched alkyl group having 1 to 20 carbon atoms (preferably having from 1 to 6 carbon atoms, and more preferably having from 1 to 4 carbon atoms).

Specific examples of the linear alkyl group include a methyl group, an ethyl group, a n-propyl group, a n-butyl group, a n-pentyl group, a n-hexyl group, a n-heptyl group, a n-octyl group, a n-nonyl group, a n-decyl group, a n-undecyl group, a n-dodecyl group, a n-tridecyl group, a n-tetradecyl group, a n-pentadecyl group, a n-hexadecyl group, a n-heptadecyl group, a n-octadecyl group, a n-nonadecyl group, and a n-eicosyl group.

Specific examples of the branched alkyl group include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, an isoundecyl group, a sec-undecyl group, a tert-undecyl group, a neoundecyl group, an isododecyl group, a sec-dodecyl group, a tert-dodecyl group, a neododecyl group, an isotridecyl group, a sec-tridecyl group, a tert-tridecyl group, a neotridecyl group, an isotetradecyl group, sec-tetradecyl group, a tert-tetradecyl group, a neotetradecyl group, a 1-isobutyl-4-ethyloctyl group, an isopentadecyl group, a sec-pentadecyl group, tert-pentadecyl group, a neopentadecyl group, an isohexadecyl group, a sec-hexadecyl group, a tert-hexadecyl group, a neohexadecyl group, a 1-methylpentadecyl group, an isoheptadecyl group, a sec-heptadecyl group, a tert-heptadecyl group, a neoheptadecyl group, an isooctadecyl group, a sec-octadecyl group, a tert-octadecyl group, a neooctadecyl group, an isononadecyl group, a sec-nonadecyl group, a tert-nonadecyl group, a neononadecyl group, a 1-methyloctyl group, an isoeicosyl group, a sec-eicosyl group, a tert-eicosyl group, and a neoeicosyl group.

Among these lower alkyl groups such as a methyl group, an ethyl group, and an isopropyl group are preferable as the alkyl group.

In the formula (CT1), examples of the alkoxy groups represented by R^{C11}, R^{C12}, R^{C13}, R^{C14}, R^{C15}, and R^{C16} include a linear or branched alkoxy group having from 1 to 20 carbon atoms (preferably haying from 1 to 6 carbon atoms, and more preferably having from 1 to 4 carbon atoms).

Specific examples of the linear alkoxy group include a methoxy group, an ethoxy group, a n-propoxy group, a n-butoxy group, a n-pentyloxy group, a n-hexyloxy group, a n-heptyloxy group, a n-octyloxy group, a n-nonyloxy group, a n-decyloxy group, a n-undecyloxy group, a n-dodecyloxy group, a n-tridecyloxy group, a n-tetradecyloxy group, a n-pentadecyloxy group, a n-hexadecyloxy group, a n-heptadecyloxy group a n-octadecyloxy group a n-nonadecyloxy group, and a n-eicosyloxy group.

Specific examples of the branched alkoxy group include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an isodecyloxy group, a sec-decyloxy group, a tert-decyloxy group, an isoundecyloxy group, a sec-undecyloxy group, a tert-undecyloxy group, a neoundecyloxy group, an isododecyloxy group, a sec-dodecyloxy group, tert-dodecyloxy group, a neododecyloxy group, an isotridecyloxy group, a sec-tridecyloxy group, a tert-tridecyloxy group, a neotridecylooxy group, an isotetradecyloxy group, a sec-tetradecyloxy group, a tert-tetradecyloxy group, a neotetradecyloxy group, a 1-isobutyl-4-ethyloctyloxy group, an isopentadecyloxy group, a sec-pentadecyloxy group, a tert-pentadecyloxy group, a neopentadecyloxy group, an isohexadecyloxy group, sec-hexadecyloxy group, a tert-hexadecyloxy group, neohexadecyloxy group, a 1-methylpentadecyloxy group, an isoheptadecyloxy group, a sec-heptadecyloxy group, a tert-heptadecyloxy group, a neoheptadecyloxy group, an isooctadecyloxy group, a sec-octadecyloxy group, a tert-octadecyloxy group, a neooctadecyloxy group, isononadecyloxy group, a sec-nonadecyloxy group, a tert-nonadecyloxy group, neononadecyloxy group, a 1-methyloctyloxy group, an isoeicosytoxy group, a sec-eicosyloxy group, a tert-eicosyloxy group, and a neoeicosyloxy group.

Among these, a methoxy group is preferable as the alkoxy group.

In the formula (CT1), examples of the aryl groups represented by R^{C11}, R^{C12}, R^{C13}, R^{C14}, R^{C15}, and R^{C16} include an aryl group having from 6 to 30 carbon atoms (preferably having from to 20 carbon atoms, and more preferably having from 6 to 16 carbon atoms).

Specific examples of the aryl group include a phenyl group, a naphthyl group, a phenanthryl group, and a biphenylyl group.

Among these, a phenyl group and a naphthyl group are preferable as the aryl group.

Furthermore, in the formula (CT1), the respective substituents represented by R^{C11}, R^{C12}, R^{C13}, R^{C14}, R^{C15}, and R^{C16} also include groups further having substituents. Examples of the substituents include atoms and groups exemplified above (for example, a halogen atom, an alkyl group, an alkoxy group, and an aryl group).

In the formula (CT1), examples of the groups linking the substituents in the hydrocarbon ring structures in which two adjacent substituents (for example, R^{C11} and R^{C12}, and R^{C13} and R^{C14}, and R^{C15} and R^{C16}) of R^{C11}, R^{C12}, R^{C13}, R^{C14}, R^{C15}, and R^{C16} linked to each other include a single bond, a 2,2′-methylene group, a 2,2′-ethylene group, and a 2,2′-vinylene group, and among these, a single bond and a 2,2′-methylene group are preferable.

Here, specific examples of the hydrocarbon ring structure include a cycloalkane structure, a cycloalkene structure, and a cycloalkanepolyene structure.

In the formula (CT1), cm and cn are preferably 1.

In the formula (CT1), from the viewpoint of forming a photosensitive layer having high charge transportability (the charge transport layer), it is preferable that R^{C11}, R^{C12}, R^{C13}, R^{C14}, R^{C15}, and R^{C16} each represent a hydrogen atom, an alkyl group having from 1 to 20 carbon atoms, or an alkoxy group having from 1 to 20 carbon atoms, and cm and ca each represent 1 or 2, and it is more preferable that R^{C11}, R^{C12}, R^{C13}, R^{C14}, R^{C15}, and R^{C16} each represent a hydrogen atom, and cm and cn each represent 1.

That is, it is more preferable that the butadiene charge transport material (CT1) is a charge transport material (exemplary compound (CT1-3)) represented by the following formula (CT1A).

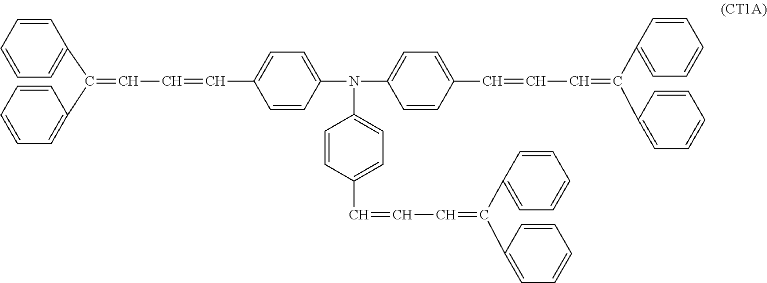 [SMILES: C(=Cc1ccc(N(c2ccc(C=CC=C(c3ccccc3)c3ccccc3)cc2)c2ccc(C=CC=C(c3ccccc3)c3ccccc3)cc2)cc1)C=C(c1ccccc1)c1ccccc1]

Specific examples of the butadiene charge transport material (CT1) are shown below, and are not limited thereto.

| Exemplary | | | | | | | | |
|---|---|---|---|---|---|---|---|---|
| Compound | | | | | | | | |
| No. | cm | cn | R^{C11} | R^{C12} | R^{C13} | R^{C14} | R^{C15} | R^{C16} |
| CTI-1 | 1 | 1 | 4-CH₃ | 4-CH₃ | 4-CH₃ | 4-CH₃ | H | H |
| CTI-2 | 2 | 2 | H | H | H | H | 4-CH₃ | 4-CH₃ |
| CTI-3 | 1 | 1 | H | H | H | H | H | H |
| CTI-4 | 2 | 2 | H | H | H | H | H | H |
| CTI-5 | 1 | 1 | 4-CH₃ | 4-CH₃ | 4-CH₃ | H | H | H |
| CTI-6 | 0 | 1 | H | H | H | H | H | H |
| CTI-7 | 0 | 1 | 4-CH₃ | 4-CH₃ | 4-CH₃ | 4-CH₃ | 4-CH₃ | 4-CH₃ |
| CTI-8 | 0 | 1 | 4-CH₃ | 4-CH₃ | H | H | 4-CH₃ | 4-CH₃ |
| CTI-9 | 0 | 1 | H | H | 4-CH₃ | 4-CH₃ | H | H |
| CTI-10 | 0 | 1 | H | H | 3-CH₃ | 3-CH₃ | H | H |
| CTI-11 | 0 | 1 | 4-CH₃ | H | H | H | 4-CH₃ | H |
| CTI-12 | 0 | 1 | 4-OCH₃ | H | H | H | 4-OCH₃ | H |
| CTI-13 | 0 | 1 | H | H | 4-OCH₃ | 4-OCH₃ | H | H |
| CTI-14 | 0 | 1 | 4-OCH₃ | H | 4-OCH₃ | H | 4-OCH₃ | 4-OCH₃ |
| CTI-15 | 0 | 1 | 3-CH₃ | H | 3-CH₃ | H | 3-CH₃ | H |
| CTI-16 | 1 | 1 | 4-CH₃ | 4-CH₃ | 4-CH₃ | 4-CH₃ | 4-CH₃ | 4-CH₃ |
| CTI-17 | 1 | 1 | 4-CH₃ | 4-CH₃ | H | H | 4-CH₃ | 4-CH₃ |
| CTI-18 | 1 | 1 | H | H | 4-CH₃ | 4-CH₃ | H | H |
| CTI-19 | 1 | 1 | H | H | 3-CH₃ | 3-CH₃ | H | H |
| CTI-20 | 1 | 1 | 4-CH₃ | H | H | H | 4-CH₃ | H |
| CTI-21 | 1 | 1 | 4-OCH₃ | H | H | H | 4-OCH₃ | H |
| CTI-22 | 1 | 1 | H | H | 4-OCH₃ | 4-OCH₃ | H | H |
| CTI-23 | 1 | 1 | 4-OCH₃ | H | 4-OCH₃ | H | 4-OCH₃ | 4-OCH₃ |
| CTI-24 | 1 | 1 | 3-CH₃ | H | 3-CH₃ | H | 3-CH₃ | H |

Furthermore, the abbreviated symbols in the exemplary compounds represent the following meanings. Further, the numbers attached before the substituents represent the substitution positions with respect to the benzene ring.
—CH₃: Methyl group
—OCH₃: Methoxy group

The butadiene charge transport material (CT1) may be used alone or in combination of two or more kinds thereof.

As the charge transport material, the benzidine charge transport material (CT2) represented by the following formula (CT2) is preferable from a viewpoint of the charge mobility. From a viewpoint of the charge mobility, it is preferable to use the butadiene charge transport material (CT1) and the benzidine charge transport material (CT2) in combination.

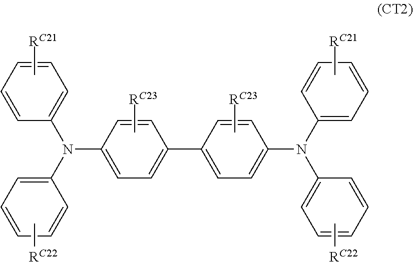

In the formula (CT2), R^{C21}, R^{C22}, and R^{C23} each independently represent a hydrogen atom, a halogen atom, an alkyl group having from 1 to 10 carbon atoms, an alkoxy group having from 1 to 10 carbon atoms, or an aryl group having from 6 to 10 carbon atoms.

In the formula (CT2), examples of the halogen atoms represented by R^{C21}, R^{C22}, and R^{C23} include a fluorine atom, a chlorine atom, a bromine atom, and an iodine atom. Among these, as the halogen atom, a fluorine atom and a chlorine atom are preferable, and a chlorine atom is more preferable.

In the formula (CT2), examples of the alkyl groups represented by R^{C21}, R^{C22}, and R^{C23} include a linear or branched alkyl group having from 1 to 10 carbon atoms (preferably having from 1 to 6 carbon atoms, and more preferably having from 1 to 4 carbon atoms).

Specific examples of the linear alkyl group include a methyl group, an ethyl group, a n-propyl group, a n-butyl group, a n-pentyl group, a n-hexyl group, a n-heptyl group, a n-octyl group, a n-nonyl group, and a n-decyl group.

Specific examples of the branched alkyl group include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, and a tert-decyl group.

Among these, lower alkyl groups such as a methyl group, an ethyl group, and an isopropyl group are preferable as the alkyl group.

In the formula (CT2), examples of the alkoxy groups represented by R^{C21}, R^{C22}, and R^{C23} include a linear or branched alkoxy group having from 1 to 10 carbon atoms (preferably having from 1 to 6 carbon atoms, and more preferably having from 1 to 4 carbon atoms).

Specific examples of the linear alkoxy group include a methoxy group, an ethoxy group, a n-propoxy group, a n-butoxy group, a n-pentyloxy group, a n-hexyloxy group, a n-heptyloxy group, a n-octyloxy group, a n-nonyloxy group, and a n-decyloxy group.

Specific examples of the branched alkoxy group include an isopropoxy group, an isobutoxy group, a sec-butoxy group, a tert-butoxy group, an isopentyloxy group, a neopentyloxy group, a tert-pentyloxy group, an isohexyloxy group, sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an isodecyloxy group, a sec-decyloxy group, and a tert-decyloxy group.

Among these, a methoxy group is preferable as the alkoxy group.

In the formula (CT2), examples of the aryl groups represented by RC²¹, RC²², and RC²³ include an aryl group having from 6 to 10 carbon atoms (preferably having from 6 to 9 carbon atoms, and more preferably having from 6 to 8 carbon atoms).

Specific examples of the aryl group include a phenyl group and a naphthyl group.

Among these, a phenyl group is preferable as the aryl group.

Moreover, in the formula (CT2), the respective substituents represented by R^{C21}, R^{C22}, and R^{C23} also include groups further having substituents. Examples of the substituents include atoms and groups exemplified above (for example, a halogen atom, an alkyl group, an alkoxy group, and an aryl group).

In the formula (CT2), particularly from the viewpoint of forming a photosensitive layer having high charge transportability (the charge transport layer) (for high sensitivity of the photoreceptor), it is preferable that R^{C21}, R^{C22}, and R^{C23} each independently represent a hydrogen atom or an alkyl group having from 1 to 10 carbon atoms, and it is more preferable that R^{C21} and R^{C23} represent a hydrogen atom, and R^{C22} represents an alkyl group having from 1 to 10 carbon atoms (particularly a methyl group).

Specifically, it is particularly preferable that the benzidine charge transport material (CT2) is a charge transport material (exemplary compound (CT2-2)) represented by the following formula (CT2A).

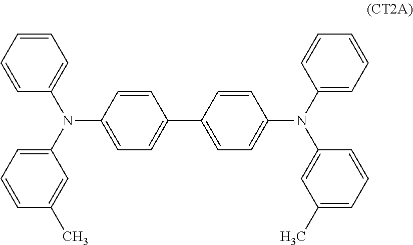 [SMILES: Cc1cccc(N(c2ccccc2)c2ccc(-c3ccc(N(c4ccccc4)c4cccc(C)c4)cc3)cc2)c1]

Specific examples of the benzidine charge transport material (CT2) are shown below, and are not limited thereto.

| Exemplary Compound | | | |
|---|---|---|---|
| No. | R^{C21} | R^{C22} | R^{C23} |
| CT2-1 | H | H | H |
| CT2-2 | H | 3-CH₃ | H |
| CT2-3 | H | 4-CH₃ | H |
| CT2-4 | H | 3-C₂H₅ | H |
| CT2-5 | H | 4-C₂H₅ | H |
| CT2-6 | H | 3-OCH₃ | H |
| CT2-7 | H | 4-OCH₃ | H |
| CT2-8 | H | 3-OC₂H₅ | H |
| CT2-9 | H | 4-OC₂H₅ | H |
| CT2-10 | 3-CH₃ | 3-CH₃ | H |
| CT2-11 | 4-CH₃ | 4-CH₃ | H |
| CT2-12 | 3-C₂H₅ | 3-C₂H₅ | H |
| CT2-13 | 4-C₂H₅ | 4-C₂H₅ | H |
| CT2-14 | H | H | 2-CH₃ |
| CT2-15 | H | H | 3-CH₃ |
| CT2-16 | H | 3-CH₃ | 2-CH₃ |
| CT2-17 | H | 3-CH₃ | 3-CH₃ |
| CT2-18 | H | 4-CH₃ | 2-CH₃ |
| CT2-19 | H | 4-CH₃ | 3-CH₃ |
| CT2-20 | 3-CH₃ | 3-CH₃ | 2-CH₃ |
| CT2-21 | 3-CH₃ | 3-CH₃ | 3-CH₃ |
| CT2-22 | 4-CH₃ | 4-CH₃ | 2-CH₃ |
| CT2-23 | 4-CH₃ | 4-CH₃ | 3-CH₃ |

Furthermore, the abbreviated symbols in the exemplary compounds represent the following meanings. Further, the numbers attached before the substituents represent the substitution positions with respect to the benzene ring.
—CH₃: Methyl group
—C₂H₅: Ethyl group
—OCH₃: Methoxy group
—OC₂H₅: Ethoxy group

The benzidine charge transport material (CT2) may be used alone or in combination of two or more kinds thereof.

As the charge transporting polymer material, known materials having charge transporting properties, such as poly-N-vinylcarbazole and polysilane are used. In particular, a polyester charge transporting polymer material is particularly preferable. The charge transporting polymer material may be singly used, or may be used along with a binder resin.

Examples of the binder resin used in the charge transport layer include polycarbonate resins, polyester resins, polyarylate resins, methacrylic resins, acrylic resins, polyvinyl chloride resins, polyvinylidene chloride resins, polystyrene resins, polyvinyl acetate resins, styrene-butadiene copolymers, vinylidene chloride-acrylonitrile copolymers vinyl chloride-vinyl acetate copolymers, vinyl chloride-vinyl acetate-maleic anhydride copolymers, silicone resins, silicone alkyd resins, phenol-formaldehyde resins, styrene-alkyd resins, poly-N-vinylcarbazole, and polysilane. Among these, polycarbonate resins or polyarylate resins are suitable as the binder resin. These binder resins may be used alone or in combination of two or more kinds thereof.

In addition, the blend ratio of the charge transport material to the binder resin is preferably from 10:1 to 1:5 in terms of weight ratio.

The charge transport layer may contain other known additives.

A technique for forming the charge transport layer is not particularly limited, and known forming methods are used. For example, formation of the charge transport layer is carried out by forming a coating film of a coating liquid for forming a charge transport layer, prepared by adding the components to a solvent, and then drying the coating film, followed by heating as desired.

Examples of the solvent for preparing the coating liquid for forming a charge transport layer are common organic solvents including, for example, aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. These solvents may be used alone or as a mixture of two or more kinds thereof.

Examples of a coating method used in coating the charge generation layer with the coating liquid for forming a charge transport layer include common methods such as a blade coating method, a wire bar coating method, a spray coating method, a dip coating method, a bead coating method, an air knife coating method, and a curtain coating method.

The film thickness of the charge transport layer is, for example, set to be in the range from preferably from 5 μm to 50 μm and more preferably from 10 μm to 30 μm.

Protective Layer

The protective layer is provided on the photosensitive layer, as desired. The protective layer is provided, for example, for the purpose of preventing the chemical changes of the photosensitive layer during charging, and further improving the mechanical strength of the photosensitive layer

Accordingly, as the protective layer, a layer formed of a cured film (crosslinked film) may be applied. Examples of this layer include the layers described in 1) and 2) below.

1) A layer formed of a cured film of a composition that includes a reactive group-containing charge transport material that has a reactive group and a charge transporting skeleton in the same molecule (that is, a layer that includes a polymer or crosslinked product of the reactive group-containing charge transport material)

2) A layer formed of a cured film of a composition that includes an unreactive charge transport material and a reactive group-containing non-charge transport material that has no charge transporting skeleton but has a reactive group (that is, a layer that includes a polymer or a crosslinked product of an unreactive charge transport material and a reactive group-containing non-charge transport material).

Examples of the reactive group of the reactive group-containing charge transport material include known reactive groups such as a chain polymerizable group, an epoxy group, —OH, —OR [in which R represents an alkyl group], —NH₂, —SH, —COOH, and —SiR^{Q1}_{3-Qn}(OR^{Q2})_{Qn} [in which R^{Q1} represents a hydrogen atom, an alkyl group, or a substituted or unsubstituted aryl group, R^{Q2} represents a hydrogen atom, an alkyl group, or a trialkylsilyl group, and Qn represents an integer of from 1 to 3].

The chain polymerizable group is not particularly limited as long as it is a radically polymerizable functional group. For example, it is a functional group which has at least a group containing a carbon-carbon double bond. Specific examples thereof include a group that contains at least one selected from the group consisting of a vinyl group, a vinyl ether group, a vinyl thioether group, a vinylphenyl group, an acryloyl group, a methacryloyl group, and derivatives thereof. Among these, a group that contains at least one selected from the group consisting of a vinyl group, a vinylphenyl group, an acryloyl group, a methacryloyl group, and derivatives thereof is preferable as the chain polymerizable group from the viewpoint of its excellent reactivity.

The charge transporting skeleton of the reactive group-containing charge transport material is not particularly limited as long as it is a known structure for n electrophotographic photoreceptor. Examples thereof include skeletons derived from nitrogen-containing hole transport compounds such as triarylamine compounds, benzidine compounds, and hydrazone compounds, in which the structure is conjugated with a nitrogen atom. Among these, a triarylamine skeleton is preferable.

The reactive group-containing charge transport material having a reactive group and a charge transporting skeleton, the unreactive charge transport material, and the reactive group-containing non-charge transport material may be selected from known materials.

The protective layer may further include other known additives.

A technique for forming the protective layer is not particularly limited, and known methods are used. For example, the formation is carried out by forming a coating film from a coating liquid for forming a protective layer, prepared by adding the components to a solvent, and drying the coating film, followed by a curing treatment such as heating, as desired.

Examples of the solvent used for preparing the coating liquid for forming a protective layer include aromatic solvents such as toluene and xylene; ketone solvents such as methyl ethyl ketone, methyl isobutyl ketone, and cyclohexanone; ester solvents such as ethyl acetate and butyl acetate; ether solvents such as tetrahydrofuran and dioxane; cellosolve solvents such as ethylene glycol monomethyl ether; and alcohol solvents such as isopropyl alcohol and butanol. These solvents may be used alone or as a mixture of two or more kinds thereof.

Furthermore, the coating liquid for forming a protective layer may be a solvent-free coating liquid.

Examples of the coating method used for coating the photosensitive layer (for example, the charge transport layer) with the coating liquid for forming a protective layer include common methods such as a dip coating method, a lift coating method, a wire bar coating method, a spray coating method, a blade coating method, a knife coating method, and a curtain coating method.

The film thickness of the protective layer is set to be, for example, preferably in the range from 1 μm to 20 μm, and more preferably in the range from 2 μm to 10 μm.

Single-Layer Type Photosensitive Layer

The single-layer type photosensitive layer (charge generation/charge transport layer) is a layer which contains, for example, a charge generating material, a charge transporting material, and, if necessary, a binder resin and other well-known additives. These materials are similar to the materials described for the charge generation layer and the charge transport layer.

The content of the charge generating material in the single-laver type photosensitive layer may be from 10% by weight to 85% by weight, with respect to the total solid content. The content of the charge generating material is preferably from 20% by weight to 50% by weight. The content of the charge transporting material in the single-layer type photosensitive layer may be from 5% by weight to 50% by weight with respect to the total solid content.

A forming method of the single-layer type photosensitive layer is similar to the forming method of the charge generation layer or the charge transport layer.

The film thickness of the single-layer type photosensitive layer may be, for example, from 5 μm to 50 μm. The film thickness of the single-layer type photosensitive layer is preferably from 10 μm to 40 μm.

Charging Device

The charging device (an example of the charging unit) 15 charges the surface of the photoreceptor 7. The charging device 15 is configured to include, for example, a power source (an example of a voltage applying unit for a charging member) 28 which applies a charging potential to a charging member 14 for charging the surface of the photoreceptor 7. The power source 28 is electrically connected to the charging member 14.

The charging member 14 of the charging device 15 is provided, for example, in a manner of contact or non-contact with the surface of the photoreceptor 7. Examples of the charging member 14 include a contact type charger which uses a conductive charging roller, a charging brush, a charging film, a charging rubber blade, a charging tube, or the like is used. Further, for example, known chargers such as a roller charger of a non-contact charging type, a scorotron charger or a corotron charger using corona discharge are also exemplified.

The charging device (including the power source 28) 15 is electrically connected to, for example, a control device 36 provided in the image forming apparatus 10. The charging device 15 drives by a control of the control device 36, so as to apply a charging voltage to the charging member 14. The charging member 14 to which the charging voltage has been applied from the power source 28 charges the photoreceptor 7 so as to have a charging potential depending on the applied charging voltage. Thus, adjusting the charging voltage applied from the power source 28 causes the photoreceptor 7 to be charged so as to have various charging potentials.

Electrostatic Latent Image Forming Device

The electrostatic latent image forming device (exposure device) (an example of the electrostatic latent image forming unit) 16 forms an electrostatic latent image on the charged surface of the photoreceptor 7.

Specifically, for example, the electrostatic latent image forming device 16 is electrically connected to the control device 36 provided in the image forming apparatus 10. The electrostatic latent image forming device 16 drives by a control of the control device 36, so as to expose the surface of the photoreceptor 7 which has been charged by the charging member 14. The exposure is performed to light L which has been modulated based on image information of an image to be formed. The electrostatic latent image forming device 16 forms an electrostatic latent, image corresponding to an image of image information, on the photoreceptor 7. The exposed surface of the photoreceptor has a potential-after-exposure in accordance with intensity of exposing light of the electrostatic latent image forming device.

Examples of the electrostatic latent image forming device 16 include an exposure device such as an optical instrument which performs exposure to light such as semiconductor laser light, light emitting diode (LED) light, liquid crystal shutter light or the like, in an imagewise manner. The wavelength of the light source may be in a spectral sensitivity region of the electrophotographic photoreceptor 7. For the wavelength of the semiconductor laser light, for example, the near-infrared ray having an emission wavelength at near 780 nm may be used. However, the wavelength of the light source is not limited to this wavelength. A laser having a wavelength in the band of 600 nm, or a blue laser having a wavelength from 400 nm to 450 nm may also be used. As the electrostatic latent image forming device 16, a surface light-emitting type laser light source that may output multiple beams is also available for color image formation, for example.

Developing Device

The developing device 18 is provided, for example, on a downstream side of an application position of light L by the electrostatic latent image forming device 16, in the rotation direction of the photoreceptor 7. A collection unit that collects a developer is provided in the developing device 18.

The developer collected in the developing device 18 may be a single-component developer configured by a toner alone, or a two-component developer that includes a toner and a carrier. The developer may be magnetic or nonmagnetic.

The developing device 18 is configured to include, for example, a developing member 18A and a power source (an example of a voltage applying unit for a developing member) 32. The developing member 18A develops the electrostatic latent image formed on the surface of the photoreceptor 7, by using a developer containing a toner. The power source 32 applies a developing voltage to the developing member 18A. The developing member 18A is electrically connected to the power source 32, for example.

The developing member 18A of the developing device 18 may be selected in accordance with the type of the developer. Examples of the developing member 18A include a developing roller which has a developing sleeve in which a magnet is provided.

The developing device (including the power source 32) 18 is electrically connected to the control device 36 provided in the image forming apparatus 10, for example. The developing device 18 drives by a control of the control device 36, so as to apply a developing voltage to the developing member 18A. The developing member 18A to which the developing voltage has been applied from the power source 32 is charged so as to have a developing potential which depends on the applied developing voltage.

The developing member 18A charged so as to have the developing potential holds the developer collected in, for example, the developing device 18, on the surface of the developing member 18A. The developing member 18A supplies the toner contained in the developer, to the surface of the photoreceptor 7 from the developing device 18.

The toner supplied onto the photoreceptor 7 adheres to, for example, the electrostatic latent image on the photoreceptor 7 by an electrostatic force. In detail, for example, a potential difference in a region in which the photoreceptor 7 and the developing member 18A face each other, that is, a potential difference between a potential of the surface of the photoreceptor 7 and the developing potential of the developing member 18A in this region causes the toner contained in the developer to be supplied to a region of the photoreceptor 7, in which the electrostatic latent image has been formed. In a case where the developer contains a carrier, the carrier is brought back into the developing device 18 in a state of being held in the developing member 18A.

Thus, for example, the electrostatic latent image on the photoreceptor 7 is developed by the toner supplied from the developing member 18A. Thus, a toner image corresponding to the electrostatic latent image is formed on the photoreceptor 7.

Transfer Device

The transfer device (an example of a transfer unit) 31 is provided, for example, on a downstream side of a position of the developing member 18A, in the rotation direction of the photoreceptor 7.

The transfer device 31 is configured to include, for example, a transfer member 20 and a power source (an example of a voltage applying unit for a transfer member) 30. The transfer member 20 transfers the toner image formed on the surface of the photoreceptor 7, to paper (an example of a recording medium) P. The power source 30 applies a transfer voltage to the transfer member 20. The transfer member 20 is, for example, columnar. The transfer member 20 rotates in a direction indicated by an arrow C, and transports the paper interposed between the transfer member 20 and the photoreceptor 7. The transfer member 20 is electrically connected to the power source 30, for example.

Examples of the transfer member 20 in the transfer device 31 include a contact-type transfer charger using a belt, a roller, a film, a rubber blade, or the like, and known non-contact type transfer chargers such as scorotron transfer chargers and corotron transfer chargers, each utilizing corona discharge.

The transfer device (including the power source 30) 31 is electrically connected to the control device 36 provided in the image forming apparatus 10, for example. The transfer device 31 drives by a control of the control device 36, so as to apply a transfer voltage to the transfer member 20. The transfer member 20 to which the transfer voltage is applied from the power source 32 is charged so as to have a transfer potential depending on the applied transfer voltage.

If the transfer voltage having a polarity opposite to that of the toner constituting the toner image which has been formed on the photoreceptor 7 is applied to the transfer member 20 from the power source 30 of the transfer member 20, an electric field is formed, for example, in a region (in FIG. 1, see a transfer region T) in which the photoreceptor 7 and the transfer member 20 face each other. The formed electric field has field strength as strong as that the toner constituting the toner image on the photoreceptor 7 is moved from the photoreceptor 7 to the transfer member 20 side by an electrostatic force.

The paper (an example of a recording medium) P is stored, for example, in a storing unit of which illustration is omitted. The paper P is transported from the storing unit on a transporting path 34 by plural transporting members of which illustrations are omitted. Then, the paper P reaches the transfer region T which is the region in which the photoreceptor 7 and the transfer member 20 face each other. In the example illustrated in FIG. 1, the paper is transported in a direction indicated by an arrow B. For example, a transfer electric field formed in this region by applying the transfer voltage to the transfer member 20 causes the toner image on the photoreceptor 7 to be transferred to the paper P which has reached the transfer region T. That is, for example, the toner is moved from the surface of the photoreceptor 7 to the paper P, and thus the toner image is transferred onto the paper P.

The toner image on the photoreceptor 7 is transferred onto the paper P by the transfer electric field. Strength of the transfer electric field is controlled based on a transfer current value.

Here, “the transfer current value” indicates a current value of the transfer current which flow into the photoreceptor from the transfer unit when a toner image is transferred to a recording medium from the photoreceptor.

The transfer current value is preferably from 50 μA to 200 μA, and more preferably from 75 μA to 150 μA, from a viewpoint of achieving prevention of poor transfer and prevention of the occurrence of fog.

Recharging Device

The recharging device (an example of a recharging unit) 40 charges the electrophotographic photoreceptor after the toner image has been directly transferred onto the surface of the recording medium. The recharging device 40 is configured to include, for example, a power source (not illustrated) for applying the charging potential to a recharging member 40A. The power source (not illustrated) is electrically connected to the recharging member 40A, for example.

The recharging member 40A of the recharging device 40 is provided so as not to be in contact with the surface of the photoreceptor 7. Examples of the recharging member 40A include known chargers such as a roller charger of a non-contact. charging type, a scorotron charger or a corotron charger using corona discharge.

The recharging device 40 is electrically connected to the control device 36 provided in the image forming apparatus 10, for example. The recharging device 40 drives by a control of the control device 36, so as to apply a charging voltage to the recharging member 40A. The voltage to be applied may be a DC voltage. The recharging member 40A to which the charging voltage is applied from a power source (not illustrated) charges the surface of the photoreceptor 7 so as to have the charging potential depending on the applied charging voltage, after the toner image has been transferred to the paper P.

The recharging device 40 is charged so as to have the same polarity as the charging device 15. For example, the recharging device 40 charges the photoreceptor 7, and thus charges accumulated in the photoreceptor 7 by the transfer device 31 are cancelled. The recharging device 40 charges the photoreceptor 7, and thus charging of the residual toner remaining on the surface of the photoreceptor 7 is easily controlled. Thus, the residual toner is easily recollected by the cleaning device 22, for example.

Cleaning Device

The cleaning device (an example of a cleaning unit) 22 is provided on the downstream side of the transfer region T in the rotation direction of the photoreceptor 7.

The cleaning device 22 removes matters adhered to the photoreceptor 7, after the toner image has been transferred to the paper P (that is, the cleaning device 22 performs cleaning of the surface of the photoreceptor 7).

The cleaning device 22 removes the adhesive matters such as the residual toner or paper powder on the photoreceptor 7. The cleaning device 22 may have, for example, a configuration in which a cleaning blade 22A which contacts with the photoreceptor 7 at predetermined linear pressure is provided. The cleaning blade 22A may contact with the photoreceptor 7 at linear pressure of 10 g/cm to 150 g/cm, for example.

Erasing Device

The erasing device (an example of an erasing unit) 24 is provided, for example, on a downstream side of the cleaning device 22 in the rotation direction of the photoreceptor 7.

The erasing device 24 exposes the surface of the photoreceptor 7 so as to perform erasing, after the toner image has been transferred.

Specifically, for example, the erasing device 24 is electrically connected to the control device 36 provided in the image forming apparatus 10. The erasing device 24 drives by a control of the control device 36, and thus exposes the entirety (specifically, for example, the entire surface of an image-forming region) of the surface of the photoreceptor 7 so as to perform erasing.

Examples of the erasing device 24 include a device which includes a light source such as a tungsten lamp for irradiation with white light, and a light-emitting diode (LED) for irradiation with red light.

Fixing Device

The fixing device (an example of a fixing unit) 26 is provided, for example, on the transporting path 34 of the paper P on a downs team side of the transfer region T in a transport direction of the paper P.

The fixing device 26 fixes the toner image transferred onto the paper P, for example.

Specifically, for example, the fixing device 26 is electrically connected to the control device 36 provided in the image forming apparatus 10. The fixing device 26 drives by a control of the control device 36, so as to fix the toner image transferred to the paper P, to the paper P by heating or by heating and pressing.

Examples of the fixing device 26 include known fixing machines such as a heat roller fixing machine and an oven fixing machine. FIG. 1 illustrates the heat roller fixing machine which includes a heating roll 26A and a pressure roll 26B disposed so as to face the heating roll 26A.

Here, the paper P to which the toner image has been transferred by being transported on the transporting path 34 and passing through the region (transfer region T) in which the photoreceptor 7 and the transfer member 20 face each other reaches an installation position of the fixing device 26 along the transporting path 34 by the transporting member (illustration is omitted). Thus, the toner image on the paper P is fixed.

The paper P on which an image is formed by fixing the toner image is discharged to the outside of the image forming apparatus 10 by plural transporting members (illustrations will be omitted).

The photoreceptor 7 is charged again by the charging device 15 after erasing by the erasing device 24.

Control Device

The control device 36 is configured as a computer for performing control of the entirety of the apparatus, and for performing various computations. Specifically, the control device 36 includes a central processing unit (CPU), a read only memory (ROM) for storing various programs therein, a random access memory (RAM) used as a work area during execution of a program, a non-volatile memory for storing various types of information, and an input and output interface (I/O). The CPU, the ROM, the RAM, the non-volatile memory, and the I/O are connected to each other through a bus. Each of the units of the image forming apparatus 10, such as the photoreceptor (including the driving motor 27) 7, the charging device (including the power source 28) 15, the electrostatic latent image forming device 16, the developing device (including the power source 32) 18, the transfer device (including the power source 30) 31, the recharging device (including the power source of which illustration is omitted) 40, the erasing device 24, and the fixing device 26 are connected to the I/O.

The CPU executes, for example, a control program of a program (for example, an image forming sequence, a restoration sequence, or the like) stored in the ROM or the non-volatile memory. Thus, the CPU controls operations of the units of the image forming apparatus 10. The RAM is used as a work memory. For example, a program to be executed by the CPU, data required for processing of the CPU, and the like are stored in the ROM or the non-volatile memory. The control program or various types of data may be stored in another storage device such as a storage unit, or may be obtained from the outside of the apparatus through a communication unit.

Various drives may be connected to the control device 36. Examples of the various drives include a device which reads data from a portable medium or writes data in the medium. The medium is computer-readable, and includes a flexible disk, a magneto-optic disk, a CD-ROM, a DVD-ROM, and an universal serial bus (USB) memory. In a case where the various drives are provided, the control program may be recorded in a portable medium, and the recorded control program may be read by the corresponding drive. Thus, the control program may be executed.

Image Forming Operation

An image forming operation of the image forming apparatus 10 will be described.

Firstly, the charging device 15 charges the surface of the photoreceptor 7. The electrostatic latent image forming device 16 exposes the charged surface of the photoreceptor 7, based on image information. Thus, an electrostatic latent image corresponding to the image information is formed on the photoreceptor 7. In the developing device 18, an electrostatic latent image formed on the surface of the photoreceptor 7 is developed by the developer containing the toner. Thus, a toner image is formed on the surface of the photoreceptor 7. In the transfer device 31, the toner image formed on the surface of the photoreceptor 7 is transferred to paper P. The toner image which has been transferred to the paper P is fixed by the fixing device 26.

The recharging device 40 recharges the surface of the photoreceptor 7 after the toner image has been transferred. Thus, charges of the opposite polarity accumulated in the photosensitive layer are cancelled. The charging is control led so as to align the polarity of the residual toner which remains on the surface of the photoreceptor 7. The cleaning device 22 performs cleaning and the erasing device 24 performs erasing.

FIG. 1 illustrates an apparatus which includes an erasing unit which irradiates an erasing light onto the surface of the photoreceptor so as to perform erasing before charging after transfer of the toner image, as the erasing device 24. However, the image forming apparatus according to the exemplary embodiment is not limited to the above configuration.

Regarding the image forming apparatus according to the exemplary embodiment, an apparatus which includes the recharging unit is described as an example. The recharging unit is disposed on the downstream side of the transfer unit after transfer of a toner image, in the rotation direction of the photoreceptor 7, and is disposed on an upstream side of the cleaning unit in the rotation direction of the photoreceptor 7. However, the image forming apparatus according to the exemplary embodiment is not limited to the above configuration.

In the image forming apparatus according to the exemplary embodiment, for example, a part including the photoreceptor 7, and the transfer device 31 may form a cartridge structure (process cartridge) which is detachable from the image forming apparatus. For example, a process cartridge which includes the photoreceptor 7 and the transfer device 31 according to the exemplary embodiment is suitably used as the process cartridge. The process cartridge may include, for example, at least one selected from a group configured from the charging unit, the electrostatic latent image forming unit, the developing unit, and the recharging unit, in addition to the photoreceptor 7.

### EXAMPLES

The exemplary embodiment will be descried below in detail by using examples. However, the exemplary embodiment is not limited to the examples. In the following description, “part (s)” and “%” are all based on weight unless otherwise specified.

Preparation of Surface-Treated Metal Oxide Particle

Surface-Treated Metal Oxide Particle 1

100 parts by weight of zinc oxide (product name: MZ-300, manufactured by Tayca Corporation, and volume average primary particle diameter: 35 nm) as metal oxide particles, 5 parts by weight or 10 wt % toluene solution of γ-aminopropyltriethoxysilane as a silane coupling agent, 200 parts by weight of toluene are mixed. The mixture is stirred and refluxed for 2 hours. Then, toluene is distilled off under reduced pressure of 10 mmHg and the residue is subjected to a baking surface treatment at 135° C. for 2 hours. Thus, surface-treated metal oxide particles are obtained.

Surface-Treated Metal Oxide Particles 2 to 6

Surface-treated metal oxide particles are obtained in a manner similar to Surface-treated metal oxide particle 1 except that the type of the metal oxide particle and an added amount (an “added amount of a coupling agent solution” in Table) of the 10 wt % toluene solution of γ-aminopropyltriethoxysilane are set as represented in Table 1.

TABLE 1

| | | | Added amount |
|---|---|---|---|
| | | | of coupling |
| Surface-treated | Metal oxide particle | | agent solution |
| metal oxide | material | | (part by |
| particle | name | product name | weight) |
| 1 | Zinc oxide | MZ-300: manufactured by | 5 |
| | | Tayca (Corp.) | |
| 2 | Zinc oxide | MZ-300: manufactured by | 10 |
| | | Tayca (Corp.) | |
| 3 | Zinc oxide | MZ-300: manufactured by | 15 |
| | | Tayca (Corp.) | |
| 4 | Zinc oxide | MZ-300: manufactured by | 20 |
| | | Tayca (Corp.) | |
| 5 | Titanium | TAF-500J: manufactured | 10 |
| | oxide | by Fuji Titan (Corp.) | |
| 6 | Tin oxide | S1: Mitsubishi Materials | 10 |
| | | (Corp.) | |

Preparation of Photoreceptor

Photoreceptor 1

Forming of Undercoat Layer

33 parts by weight of the surface-treated metal oxide particles represented in Table 2, 6 parts by weight of blocked isocyanate (product name: SUMTOUR 3175 manufactured by Sumitomo Bayer Urethane Co. Ltd.) as a curing agent, 9 parts by weight of an electron accepting compound which is represented in Table 2, and 25 parts by weight of methyl ethyl ketone are mixed for 30 minutes. Then, 5 parts by weight of a butyral resin (product name: S-LEC BM-1, manufactured by Sekisui Chemical Co., Ltd.), 3 parts by weight of a silicone ball (product name: TOSPEARL 120, manufactured by Momentive Performance Materials Inc.) and 0.01 part by weight of a silicone oil as a leveling agent (product name: SH29PA, manufactured by Toray Dow Corning Silicone Co., Ltd.) are added thereto. The mixture is dispersed for 1 hour by using a sand mill, thereby a coating liquid for forming an undercoat layer is obtained.

An aluminum substrate (electroconductive substrate) having a diameter of 84 mm, a length of 357 mm, and a thickness of 1.0 mm is coated with the coating liquid for forming an undercoat layer by a dip coating method. Then, dry curing is performed at 180° C. for 30 minutes, thereby an undercoat layer having a thickness of 20 μm is obtained.

Forming of Charge Generation Layer

15 parts by weight of a hydroxygallium phthalocyanine pigment as a charge generating material, 10 parts by weight of a vinyl chloride-vinyl acetate copolymer resin (product name: VMCH, manufactured by NUC Ltd.) as a binder resin, and 300 parts by weight of n-butyl alcohol as a solvent are mixed. The hydroxygallium phthalocyanine pigment has strong diffraction peaks at at least 7.5°, 9.9°, 12.5°, 16.3°, 18.6°, 25.1°, and 28.3° of Bragg angles (2θ±0.2°) for CuKα characteristic X-rays. The mixture is dispersed by using a sand mill for 4 hours, thereby a coating liquid for forming a charge generation layer is obtained.

The obtained coating liquid for forming a charge generation layer is applied onto the undercoat layer by a dip coating. Drying is performed at 100° C. for 10 minutes, thereby a charge generation layer having a film thickness of 0.2 μm is obtained.

Forming of Charge Transport Layer

4 parts by weight of N,N′-diphenyl-N,N′-bis (3-methylphenyl) [1,1′-biphenyl]-4,4′-diamine as a charge transporting material, 6 parts by weight of bisphenol Z polycarbonate resin (weight-average molecular weight: 40,000) as a binder resin are added to a solvent mixture of 24 parts by weight of tetrahydrofuran and 5 parts by weight of chlorobenzene. Thus, a coating liquid for forming a charge transport layer is obtained.

The obtained coating liquid for forming a charge transport layer is applied onto the charge generation layer. Drying is performed at 130° C. for 40 minutes, thereby a charge transport layer having a film thickness of 35 μm is formed. Thus, a desired electrophotographic photoreceptor is obtained.

Measuring of Electrostatic Capacitance of Undercoat Layer

The coating liquid for forming an undercoat layer obtained when the undercoat layer is formed is applied onto an aluminium substrate having a diameter of 30 mm and a length of 340 mm, by dip coating. Dry curing is performed at 180° C. for 30 minutes, thereby an undercoat layer having a thickness of 20 μm is obtained. Gold electrodes of φ6 mm as facing electrodes are formed on the undercoat layer. Measurement is performed at a normal temperature and normal humidity (22° C./50% RH) by the 126096W impedance analyzer (manufactured by Solartron Corp.). The measurement is performed at a DC bias of 0 V, AC±1V, in a frequency range of 1 to 100 Hz. Thus, electrostatic capacitance per unit area of the undercoat layer (“electrostatic capacitance” in Table) is obtained. The results are shown in Table 2.

Photoreceptors 2 to 8 and Photoreceptors C1 to C2

Electrophotographic photoreceptor is obtained in a manner similar to that for Photoreceptor 1, except that the type of a surface-treated metal oxide particle, and the type and an added amount of an electron accepting compound used in forming the undercoat layer of Photoreceptor 1 are set as represented by Table 2.

Measurement is performed by using the obtained coating liquid for forming an undercoat layer, in a manner similar to that for Photoreceptor 1, and thus electrostatic capacitance per unit area of the undercoat layer (“electrostatic capacitance” in Table) is obtained. Table 2 represents results.

Evaluation

Evaluation of Occurrence of Fog

The obtained photoreceptor is mounted in an image forming apparatus (Multifunction machines DocuCentre f11100 manufactured by Fuji Xerox. Co., Ltd.). A character chart having image density of 3% is transversely fed to a recording medium of an A4 size, and is continuously formed on 5,000 sheets under an environment of a transfer current value of 120 μA, a process speed of 400 mm/sec, a temperature of 22° C., and humidity of 50% RH. Then, the character chart having image density of 3% is formed on one sheet of a recording medium of an A3 elongated size. A non-image portion of the A3 elongated size is visually observed, and thus, the occurrence of fog is evaluated based on the following evaluation criteria. Table 2 represents results.

The occurrence of fog is evaluated similarly under conditions of a transfer current value of 250 μA and a process speed of 400 mm/sec. Table 2 represents results.

Evaluation Criteria of Occurrence of Fog

A: no fog occurs or it is difficult to recognize fog.

E: fog occurs to such a extent that the fog may be recognized only when observed well, but the degree of the fog is in an allowable range.

C: fog occurs to such an extent that the fog may be recognized easily and clearly, and the degree of the fog exceeds the allowable range.

TABLE 2

| | | | Electron accepting | | | | |
|---|---|---|---|---|---|---|---|
| | | | ompound | | | Evaluation of occurrence | |
| | | Surface-treated | | Added amount | Electrostatic | of fog | |
| | | metal oxide | | (part by | capacitance | 120 μA | 250 μA |
| | Photoreceptor | particle | Type | weight) | (F/cm²) | 400 mm/sec | 400 mm/sec |
| Example 1 | 1 | 2 | 1-2 | 9 | 1.70 × 10⁻⁹ | A | B |
| Example 2 | 2 | 3 | 1-2 | 9 | 1.24 × 10⁻⁹ | A | A |
| Example 3 | 3 | 4 | 1-2 | 9 | 8.48 × 10⁻¹⁰ | A | A |
| Example 4 | 4 | 5 | 1-2 | 9 | 1.34 × 10⁻⁹ | A | B |
| Example 5 | 5 | 6 | 1-2 | 9 | 4.95 × 10⁻¹⁰ | A | A |
| Example 6 | 6 | 2 | 1-9 | 1 | 1.59 × 10⁻⁹ | A | B |
| Example 7 | 7 | 2 | 1-14 | 1.5 | 4.24 × 10⁻¹⁰ | A | A |
| Example 8 | 8 | 2 | 1-21 | 1 | 1.24 × 10⁻⁹ | A | A |
| Comparative | C1 | 1 | 1-2 | 9 | 2.40 × 10⁻⁹ | C | C |
| Example 1 | | | | | | | |
| Comparative | C2 | 2 | None | 0 | 3.00 × 10⁻⁹ | C | C |
| Example 2 | | | | | | | |

In the example, it is recognized that the occurrence of fog is prevented in comparison to a comparative example, based on the above results.

Details of abbreviations and the like in Table 2 are as follows.
1-2: exemplary compound (1-2) of the electron accepting compound
1-9: exemplary compound (1-9) of the electron accepting compound
1-14: exemplary compound (1-14) of the electron accepting compound
1-21: exemplary compound (1-21) of the electron accepting compound

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners ski lied in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An image forming apparatus comprising:
an electrophotographic photoreceptor which includes an electroconductive substrate, an undercoat layer which is provided on the electroconductive substrate and has an electrostatic capacitance per unit area of from 2×10−10 F/cm2 to 2×10×9 F/cm2, and a photosensitive layer provided on the undercoat layer;
a charging unit that charges a surface of the electrophotographic photoreceptor;
an electrostatic latent image forming unit that forms an electrostatic latent image on a charged surface of the electrophotographic photoreceptor;
a developing unit that develops the electrostatic latent image formed on the surface of the electrophotographic photoreceptor by using a developer containing a toner, so as to form a toner image; and
a direct transfer type transfer unit that directly transfers the toner image onto a surface of a recording medium,
wherein the undercoat layer contains a binder resin, a metal oxide particle, and an electron accepting compound.

2. The image forming apparatus according to claim 1, wherein the undercoat layer has an electrostatic capacitance of from 5×10−10 F/cm2 to 1×10−9 F/cm2.

3. The image forming apparatus according to claim 1, wherein
a transport speed of the recording medium is from 400 mm/s to 700 mm/s.

4. The image forming apparatus according to claim 1, wherein
a transport speed of the recording medium is from 450 mm/s to 600 mm/s.

5. (canceled)

6. The image forming apparatus according to claim 1, wherein
the metal oxide particle includes at least one selected from the group consisting of a tin oxide particle, a titanium oxide particle, and a zinc oxide particle.

7. The image forming apparatus according to claim 1, wherein
a volume average primary particle diameter of the metal oxide particles is 100 nm or less.

8. The image forming apparatus according to claim 1, wherein
the metal oxide particle is treated with at least one coupling agent.

9. The image forming apparatus according to claim 8, wherein
the coupling agent includes at least one selected from the group consisting of a silane coupling agent, a titanate coupling agent, and an aluminum coupling agent.

10. The image forming apparatus according to claim 1, wherein
the electron accepting compound is an electron accepting compound which has an anthraquinone skeleton.

11. The image forming apparatus according to claim 10, wherein
the electron accepting compound which has the anthraquinone skeleton is a compound represented by the following formula (1):
wherein n1 and n2 each independently represent an integer of from 0 to 3, with the proviso that at least one of n1 and n2 represents an integer of from 1 to 3; ml and m2 each independently represent an integer of 0 or 1; and R11 and R12 each independently represent an alkyl group having from 1 to 10 carbon atoms, or an alkoxy group having from 1 to 10 carbon atoms.

12. The image forming apparatus according to claim 1, wherein
a thickness of the undercoat layer is from 15 μm to 30 μm.

13. The image forming apparatus according to claim 1, wherein
a thickness of the undercoat layer is from 20 μm to 25 μm.

14. The image forming apparatus according to claim 1, wherein
a volume average primary particle diameter of the metal oxide particles is 30 nm to 50 nm.
